(19) United States
(12) Patent Application Publication
(10) Pub. No.: US 2016/0249108 A1
(43) Pub. Date: Aug. 25, 2016

(54) METHOD AND APPARATUS FOR PROVIDING A CUSTOMIZED VIEWING EXPERIENCE

(71) Applicant: Live Media Group, Van Nuys, CA (US)

(72) Inventor: Brad SEXTON, Tarzana, CA (US)

(21) Appl. No.: 15/047,438

(22) Filed: Feb. 18, 2016

Related U.S. Application Data
(60) Provisional application No. 62/117,939, filed on Feb. 18, 2015.

(51) Int. Cl. H04N 21/485; H04N 5/45; H04N 21/431; G06F 3/0484; H04N 21/218; H04L 29/06; H04N 5/445

(52) U.S. Cl. CPC H04N 21/4858; H04L 65/604; H04L 67/42; H04N 5/45; H04N 5/44591; G06F 3/04845; H04N 21/21805; H04N 21/4312; G06F 3/04842

(57) ABSTRACT

Some aspects of the invention relate to a server apparatus including a content player. The server apparatus includes an interface configured to serve the content player to a client apparatus. The content player is configured to operate on the client apparatus by receiving several content streams through a single socket connection and presenting each of the content streams to a different portion of a display. The manner of presentation is configurable by a user of the client apparatus.

### CROSS-REFERENCE TO RELATED APPLICATION(S)

This application claims priority to U.S. Provisional Application Ser. No. 62/117,939 filed Feb. 18, 2015, entitled “METHOD AND APPARATUS FOR PROVIDING A CUSTOMIZED VIEWING EXPERIENCE,” which is expressly incorporated by reference herein in its entirety.

### BACKGROUND

1. Field

The present disclosure relates generally to methods and apparatuses for providing a customized viewing experience and more specifically, providing a customizable interface that enables a user to instantly view several different video streams.

2. Background

Recent years have given rise to the proliferation of users viewing content streamed over the Internet. Increases in the availability of higher network bandwidth in private homes as well as more advanced buffering schemes, protocols, and compression algorithms have all contributed in large part to an online viewing experience that is at least as good, if not better, than even the most advanced televisions. For example, by viewing content over the Internet, a user may have access to a much larger array of content and potentially higher quality content than is available over-the-air to televisions. Moreover, when viewing content using a display communicatively coupled to a computer, the user's experience is enhanced because the user can access a variety of other applications at the same time and interact with those applications while the content is streaming.

Content is typically viewed over the Internet by way of either accessing, at a client apparatus, an application or a website that downloads an instance of a content player that presents the streamed content to the user through a display at the client apparatus. The instance of the content player may be a copy of a content player served to the client by an external server. Typically, only one video can be presented for each instance of the application. For example, when the client apparatus downloads an instance of a content player and begins the content presentation, a socket connection is open between the client apparatus and the server serving the content. In such instances a new socket connection is open for each instance of the content player.

Thus, one of the drawbacks of presenting and viewing content over the Internet is that additional resources are utilized without any type of resource management scheme when multiple instances of a content player are open. This can lead to an unfavorable viewing experience. Therefore, it is difficult to provide an apparatus, which can present multiple, fully customizable, content streams over a single socket connection such that computing resources can be tracked, managed, and adjusted for a favorable viewing experience.

### SUMMARY

Several aspects of the present invention will be described more fully hereinafter with reference to various methods and apparatuses.

Some aspects of the invention relate to a server apparatus including a content player. The server apparatus includes an interface configured to serve the content player to a client apparatus. The content player is configured to operate on the client apparatus by receiving several content streams through a single socket connection and presenting each of the content streams to a different portion of a display. The manner of presentation is configurable by a user of the client apparatus.

Other aspects of the invention relate to a server apparatus including a content player. The server apparatus includes an interface configured to serve the content player to a client apparatus. The content player is configured to operate on the client apparatus by receiving several content streams and coordinating allocation of resources on the client apparatus to present each of the content streams to a different portion of a display. The manner of presentation is configurable by a user of the client apparatus.

Other aspects of the invention relate to a client apparatus including a display. The client apparatus includes a content player configured to receive several content streams through a single socket connection and concurrently present each of the content streams to a different portion of the display. The manner of presentation is configurable by a user of the client apparatus.

Other aspects of the invention relate to a client apparatus including a display. The client apparatus includes a content player configured to receive several content streams and coordinate allocation of resources to present each of the content streams to a different portion of the display. The manner of presentation is configurable by a user of the client apparatus.

Other aspects of the invention relate to a content player including a non-transitory machine-readable medium having executable code to receive several content streams through a single socket connection. The machine-readable medium has executable code to present each of the content streams to a different portion of a display. The manner of presentation is configurable by a user of the content player.

Other aspects of the invention relate to a content player including a non-transitory machine-readable medium having executable code to receive several content streams. The machine-readable medium has executable code to coordinate allocation of resources to present each of the content streams to a different portion of a display. The manner of presentation is configurable by a user of the content player.

It is understood that other aspects of methods and apparatuses will become readily apparent to those skilled in the art from the following detailed description, wherein various aspects of apparatuses and methods are shown and described by way of illustration. As understood by one of ordinary skill in the art, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of methods and apparatuses will now be presented in the detailed description by way of example, and not by way of limitation, with reference to the accompanying drawings, wherein:

FIG. 1 illustrates an exemplary embodiment of a display that provides a customized viewing experience.

FIG. 2 illustrates an exemplary embodiment of a high level modular diagram of the apparatus.

FIG. 3 conceptually illustrates an exemplary embodiment of a content distribution system.

FIG. 4 illustrates an exemplary embodiment of the platform.

FIG. 5 illustrates an exemplary embodiment of a data structure that may be used by the CMS to store event and content stream information in the database.

FIG. 6 illustrates a more expansive illustration of the exemplary embodiment of the content distribution system discussed in FIG. 3.

FIG. 7 conceptually illustrates a process for serving content stream(s) to a client apparatus.

FIG. 8 illustrates a schematic representation of an exemplary embodiment of a client apparatus or a server apparatus.

FIG. 9 illustrates an exemplary embodiment of a client/server architecture for serving a content player from a server apparatus to a client apparatus.

FIG. 10 illustrates an exemplary embodiment of the modular architecture of a client apparatus.

FIG. 11 illustrates an exemplary embodiment of a configuration of the content switch.

FIGS. 12a-12f illustrate exemplary embodiments of a variety of content stream presentations in response to user interactions with a display.

FIGS. 13a-13c illustrate an exemplary embodiment of a display in grid mode.

FIG. 14 illustrates an exemplary embodiment of a display having multiple events.

FIG. 15 illustrates an exemplary embodiment of a display that is capable of presenting different channels within an event.

FIGS. 16a-b conceptually illustrate a process for providing a fully configurable content viewing experience.

FIG. 17 illustrates an exemplary embodiment of a state diagram of a content player.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The word “exemplary” or “embodiment” is used herein to mean serving as an example, instance, or illustration. Any embodiment described herein as “exemplary” is not necessarily to be construed as preferred or advantageous over other embodiments. Likewise, the term “embodiment” of an apparatus, method or article of manufacture does not require that all embodiments of the invention include the described components, structure, features, functionality, processes, advantages, benefits, or modes of operation.

It will be further understood that the terms “comprises” and/or “comprising,” when used in this specification, specify the presence of stated features, steps, operations, elements, and/or components, but do not preclude the presence or addition of one or more other features, integers, steps, operations, elements, components, and/or groups thereof. The term “and/or” includes any and all combinations of one or more of the associated listed items.

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In the following detailed description, various aspects of the present invention will be presented in the context of apparatuses and methods for providing a fully customizable display for presenting live or recorded content. As those skilled in the art will appreciate, these aspects may be extended to a multitude of devices including personal computers, laptops, smart phones, tablets, personal data assistants (PDA), or any other device capable of connecting to the internet and displaying video content. Accordingly, any reference to an apparatus or method for providing a customized viewing experience is intended only to illustrate the various aspects of the present invention, with the understanding that such aspects may be performed on any apparatus capable of receiving a variety of different interactive options including but not limited to feedback from cursor control devices and gestural interactions from apparatuses having an interactive touch screen.

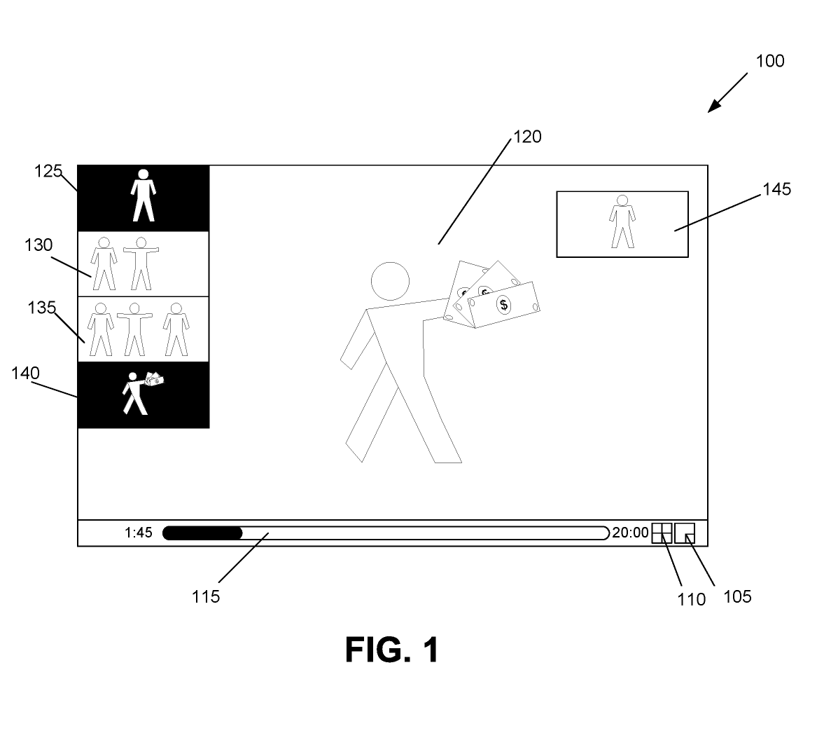

FIG. 1 illustrates an exemplary embodiment of a display 100 that provides a customized viewing experience. The display includes a display area 120, selectable objects 105 and 110, timeline 115, selectable content stream representations 125-140, and presented stream 145. A live or recorded video stream may be played in the display area 120 upon receiving a user interaction with of one of the selectable content stream representations 125-140. In such instances, each of the content stream representations 125-140 may represent different camera feeds from a same live event. As will be discussed in the foregoing sections, the display 100 may receive user interactions with the content stream representations to present the video portion of the stream in the display area 120 in any number of customizable ways. In such cases, the display 100 may also receive a selection of a presented stream for which audio may also be played. Typically, only one stream may be selected for audio playback, because playing multiple audio streams at the same time may provide an undesirable user experience. However, this limitation is only imposed for a better interactive experience and as one skilled in the art is appreciated, the apparatus of some embodiments is not limited to only playing a single audio stream.

In some embodiments of the display, selection of a content stream representation 125-140 may be performed by a user interaction such as a gestural interaction with touch screen or cursor control device including a mouse, track pad or other suitable input device communicatively coupled to a client apparatus. In this example, the display 100 has received a user interaction with the content stream representation 140 to present the corresponding content stream in the main display area as well as content stream representation 125 to present in a corner of the display area. Such interactions may be indicated by presenting the content stream representations in a manner that is visually distinct from the other content stream representations. For instance, in this exemplary embodiment, the content stream representations 140 and 125 are illustrated as having a darker appearance than the content stream representations 130-135. However, as one skilled in the art will appreciate, the distinguishing visual appearance for a selected stream is not limited to what is illustrated in FIG. 1. For instance, the visual distinctions could include different colors, outlines around the content stream representation, or any other visual differentiation.

The display 100 also includes the timeline 115 and selectable objects 110 and 115. The timeline 115 illustrates the elapsed and remaining time or total time of a presented content stream, or event. However, in some aspects of the display, the presented content stream may be a live feed, where the remaining time left on the feed is unknown. In such cases, the timeline 115 may not illustrate the total time or remaining time stream of streams.

As will be discussed in greater detail in the foregoing, the display 100 has the capability of presenting multiple streams in the display area 120. When multiple streams are presented in display area 120, the display 100 may default to one of two display modes, grid mode or picture-in-picture (PiP) mode. For instance, exemplary display 100 illustrates two video streams presented in PiP mode. However, in some instances, the viewer may wish to switch between grid mode and PiP mode. In such instances, the display 100 may receive a user interaction with selectable object 110 to activate grid mode (if it is not already activated) or the display 100 may receive a user interaction with the selectable object 105 to activate PiP mode (if it is not already activated). Grid mode and PiP mode will be discussed in greater detail in the foregoing description.

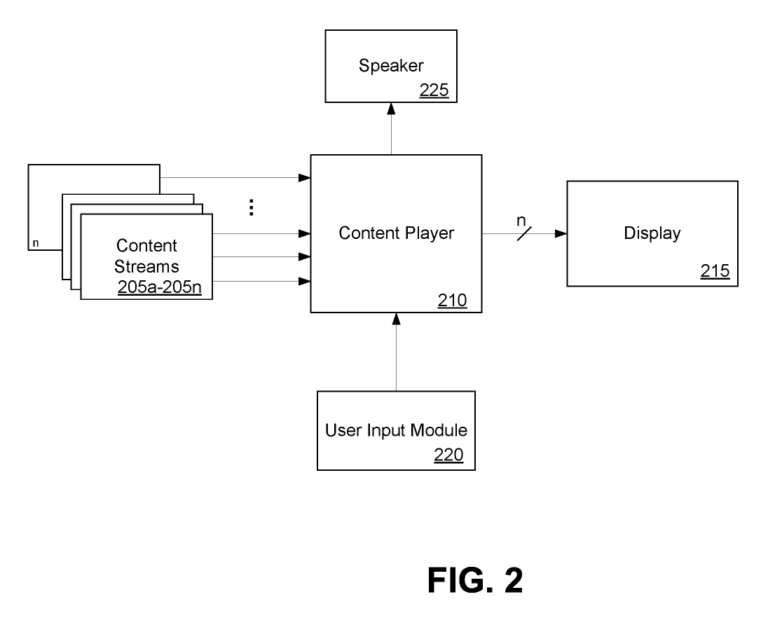

FIG. 2 illustrates an exemplary embodiment of a high level modular diagram of the apparatus. As shown, FIG. 2 includes content streams 205a-205n, content player 210, display 215, a user input module 220, and a speaker 225. The content streams may be audiovisual content streams such as those described in FIG. 1. Although in FIG. 1, four content streams were illustrated, the apparatus may include any number of n content streams. The content player 210 may select at least one of the content streams 205a-205n for presentation on the display 215. The content player 210, may select any number of streams up to a predefined number and present those stream(s) for display in any particular format. The content player 210 also receives user input from the user input module 220. The user input module 220 may process user interaction performed on the display 215 as described, for example, with respect to the display 100 in FIG. 1. The input from the user's interaction with the display 215 is then provided to the content player 210. The content player 210 will then determine which content streams to present at the display 215 and how the content streams will be presented. For instance, when more than one stream is selected, the content player 210 may present each stream in different portions of the display 215. In such instances the content player 210 may determine, based on received user input, to present the content streams in the grid format or the PiP format.

Additionally, the user input module 220 may receive input to move, resize, or rearrange the presented content streams. In such cases, the content player 210 will redisplay the presented content streams according to the received user input. For instance, if the content player 210 receives user input to resize a selected one of the content streams, the content player 210 may redisplay the presented content streams such that the selected content stream is presented at a different size.

In some embodiments of the apparatus, it is also possible to play audio for one of the content streams selected from the content player 210. In such embodiments the content player 210 will receive user input from the user input module 220 to select the content stream from which the audio is provided to the speaker 225. Such user input may include an interaction with one of the presented streams. Although FIG. 2 only illustrates a single audio stream is provided to the speaker 225, in some embodiments of the apparatus, it may be possible to provide several audio streams to one or more speakers.

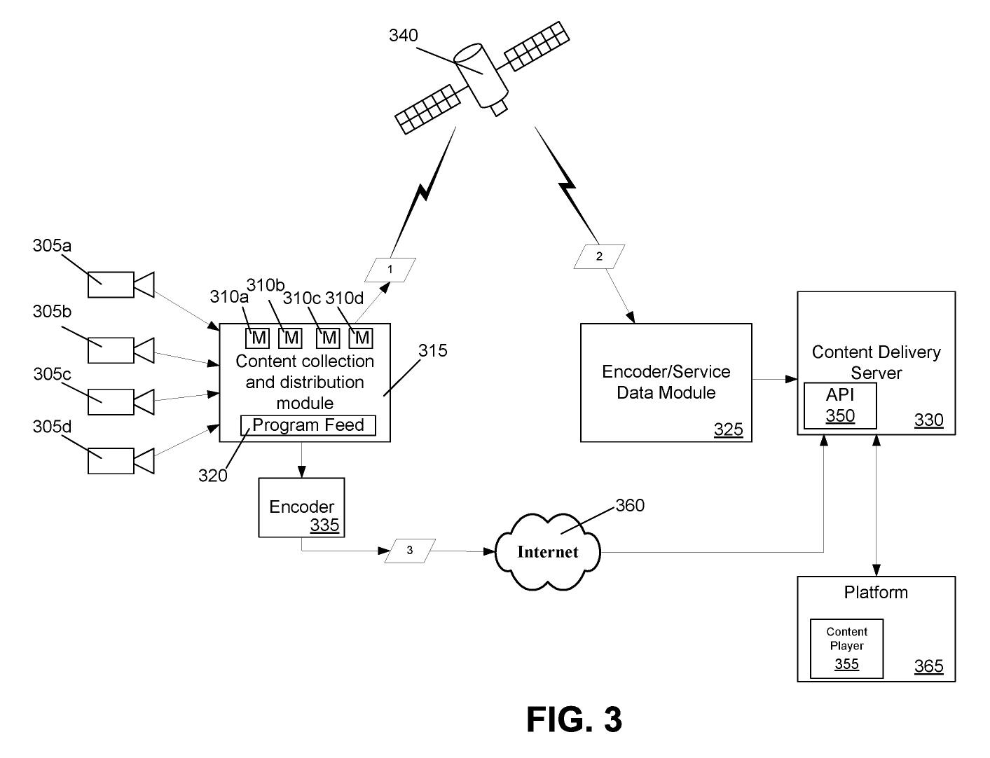

FIG. 3 conceptually illustrates an exemplary embodiment of a content distribution system. The content distribution system may be utilized to collect and wirelessly deliver several content streams to client apparatuses. The content distribution system includes camera feeds 305a-305d, a content collection and distribution module 315, a satellite 340, an encoder/service data module 325, a content delivery server 330, an encoder 335, the internet 365, and a platform 365. The content collection and distribution module includes a program feed 320 and several monitors 310a-310d. The content delivery server 330 includes an application programming interface (API) 350. The platform 365 includes a content player 355. In some embodiments, the content collection and distribution module 315 may be a mobile production truck or production studio capable of collecting several camera feeds and distributing the feeds wirelessly. For instance, the content collection and distribution module 315 may collect content feeds from the cameras 305a-305d. The cameras 305a-305d may be positioned at different locations at the same event, giving users an opportunity to see the same event from several different viewing angles.

For example, if the cameras 305a-305d and content collection and distribution module is located at a sporting event such as a football game, each camera may provide a different viewing experience. For instance, the camera 305a may provide an end zone camera, the camera 305b may provide a wide angle view of the football field, the camera 305c may provide a helmet cam view from a quarterback, and the camera 305d may provide an aerial view of the game. The program feed 320 may switch between the various camera feeds. However, all camera feeds from the cameras 305a-305d may be available to a client apparatus for a customizable viewing experience as discussed in greater detail in the foregoing. It should also be noted that the system is not confined to the above example where all cameras are located at the same event. In fact, several cameras could be located at different events while still being managed by the content collection and distribution system 315.

The cameras 305a-305d convert audiovisual feeds into electrical signals that may be rendered and viewed on the monitors 310a-310d. In some aspects of the system, the content collection and distribution module 315 may provide certain live editing capabilities before distributing the content. The content may be edited using editing equipment communicatively coupled to the monitors 310a-310d. Once the audiovisual content is ready for distribution, the content may be distributed. Additionally, the program feed 320 may be distributed along with the audiovisual content. The program feed 320 may be a traditional content feed of an event that is controlled by a director or producer inside the studio. For instance, the program feed 320 may switch between various different camera feeds at the direction of the director. The client apparatus may be able to view any of the aforementioned 5 feeds, for example.

The program feed 320 along with the audiovisual content captured from cameras 305a-305d may be encoded by the encoder 335 to a video format capable of being read by the content delivery server 330. For instance, the program feed may be converted to a format such as MPEG2, MPEG4, HLS, HDS, and/or any other suitable multimedia content format capable of being read by the content delivery server 330. The encoded content may then be transmitted as data packet 3 over the internet 360 to the content delivery server 330. The API 350 may be used by the content delivery server to receive the data packet 3 and store the relevant content on the content delivery server 330. Direct transmission to the content delivery server 330 may be possible in instances when the content collection and distribution module 315 has a direct line of communication to the Internet 360. However, in instances, where such communication is not present, the content collection and distribution module 315 may require satellite transmission.

The program feed and audiovisual content may alternatively or conjunctively be transmitted from the content collection and distribution module 315 by wireless uplink as data packet 1 to the satellite 340, the satellite 340 may then transmit data packet 2 via a downlink to the encoder/service module 325. Data packets 1 and 2 may include the audiovisual content and the program feed along with other packet header information necessary for successful transmission and unpacking (e.g., Checksum, packet number, offsets, etc.) of the content. The encoder/service data module 325 may then remove the content (data packet payload) from the data packet and encode the received content from the camera feeds 305a-305d and the program feed 320 using one of the encoding formats discussed above such that the content may be presented on a mobile apparatus or website. The encoded feed is then transmitted to the content delivery server 330 by utilizing the API 350.

The content delivery server 330 provides several functional features that may be utilized by the platform 365 and accessible through the API 350. More specifically, the content delivery server 330 may comprise a set of servers that communicate content to client apparatuses. In some embodiments, the platform 365 may request content originating from the cameras 305a-305d and/or the program feed from the content delivery server 330 by making a call and/or request through the API 350. Upon receiving the request, the content deliver server 330 may then serve the requested content and/or feed to the platform 365. The content may be communicated back to the platform 365 by way of the API 350. As will be discussed in the foregoing, the platform 365 also provides the content player 355 to a client apparatus capable of viewing the content in a number of different customizable viewing formats. The content player 355 resides on the platform 365 and an instance of the content player 355 is served to a client apparatus upon receiving a request from a client apparatus to download an instance of the content player 355. The content player instance downloaded from the platform 365 to the client apparatus may be the content player 210 discussed with respect to FIG. 2. The content player 355 resides on the platform 365 and an instance of the content player 355 is served to a client apparatus upon receiving a request from a client apparatus to download the content player 355. It should also be noted that all of the content and program feed may be delivered at the same quality. For instance, all of the content may be of high definition (HD) quality, rather than contents of varying display quality. The system, of some embodiments may verify the maximum quality content stream(s) a client can present to a display based on available hardware resources and periodically adjust the quality of the content streams accordingly.

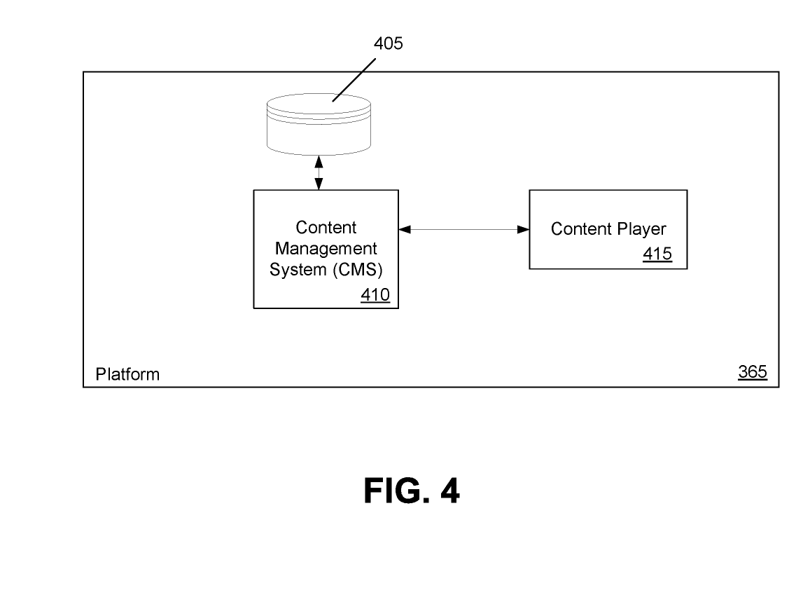

FIG. 4 illustrates an exemplary embodiment of the platform 365. The platform 365 includes a content player 415, a content management system (CMS) 410 and a database 405. The platform may be used to serve an instance of the content player 415 to any client apparatus capable of internet communication such as a personal computer, laptop, PDA, and/or smartphone.

The database 405 holds event and content information. The CMS 410 creates the event and content information and stores the information in the database 405. The event information may be related to a live or prerecorded event. As part of the event information, the CMS 410 also maintains a universal resource locator (URL) indicating, for each event, where the event content stream(s) may be retrieved from the content delivery server 330 discussed in the previous figure. The CMS may have an open connection with the content delivery server 330 by communicating with the API 350 for assigning URLs to content stream(s) provided by the content delivery server 330. Once the URL is assigned to the content stream, an instance of content player served to a client apparatus will be able to look up the location of the content stream at the CMS 410 and download the content stream from the content delivery server 330 for presentation on a display.

As will be discussed in the following figures, the content player 415 may be served to a client apparatus in order to present the content stream(s). In some embodiments, the instance of the content player served to the client apparatus is an agnostic module. In order to present the content stream(s), the content player on the apparatus must be loaded with an event ID. Once, the content player on the client apparatus is provided the event ID, the content player will then query the CMS 410 using the event ID, which will query the database 405 for the event information associated with the event ID.

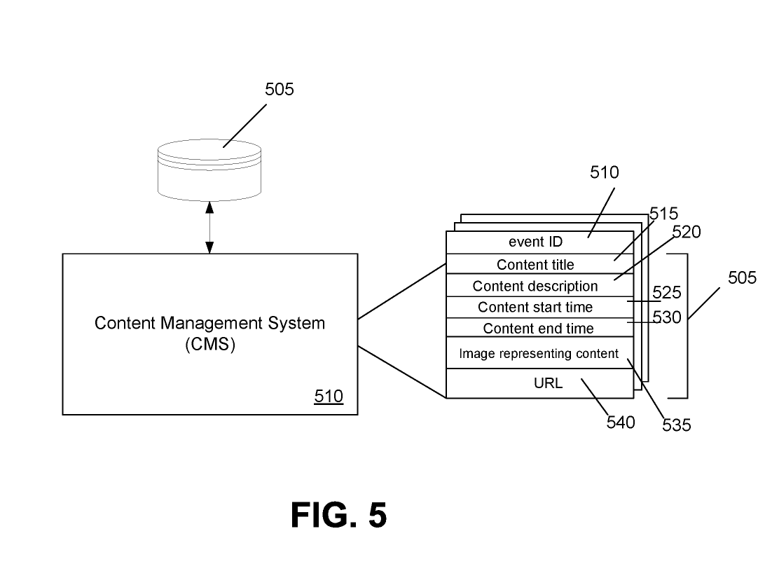

FIG. 5 illustrates an exemplary embodiment of a data structure 505 that may be used by the CMS 410 to store event and content stream information in the database 405. The data structure may include event ID 510, content title 515, content description 520, content start time 525, content end time 530, an image representing the content 535, and URL 540.

In some embodiments, the content player on the client apparatus may query the CMS with an event ID 510. The CMS 410 may associate the event ID 510 with the URL 540. The URL may provide the content player on the client apparatus with information for locating and downloading the content to the content player on the client apparatus from the content delivery server 330. The additional information 515-535 in the data structure 505 may also be used by the content player downloaded by the client apparatus to provide details about the content presented to the user. In addition to, or alternatively, the additional information 515-535 may be used for marketing or advertising purposes on a remote website before an event is broadcast.

The CMS 410 may create and store the event and/or content information using the data structure 505. The information from the data structure 505 may then be provided to the database 405 using a protocol understandable by the database 405. Additionally, the data structure 505 is not confined to the fields 510-530. For instance, the data structure 505 may include additional fields for information useful to the presentation of any content stream.

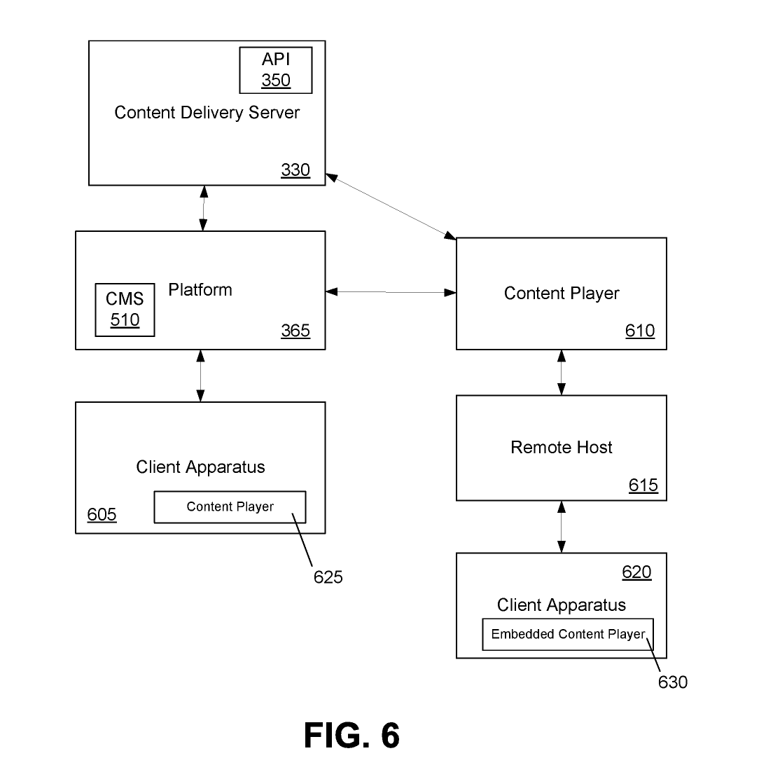

FIG. 6 illustrates a more expansive illustration of the exemplary embodiment of the content distribution system discussed in FIG. 3. The content distribution system includes the content delivery server 330, the platform 365, client apparatuses 605 and 630, a content player 610, and a remote host 615. The platform 365 includes the CMS 410. The content delivery server 330 includes the API 350. The client apparatus 605 includes a content player 625 and the client apparatus 620 includes an embedded content player 630. The content players 625 and 630 represent instances of content players downloaded from the server to the client apparatuses. The client apparatuses 605 and 620 may be a personal computer comprising a web browser or a mobile apparatus such as a smartphone. In some embodiments, the embedded content player may be embedded in an IFrame of a remote website. An IFrame is an HTML element embedded within an HTML document often used to insert content from another source into a webpage. In some embodiments, the content player 630 is embedded within an IFrame of a remote webpage. As will be discussed in the foregoing, the content player 620 is loaded from an external site into the IFrame within a webpage on the client apparatus 620.

As illustrated, the content delivery server 330 is communicatively coupled to the platform 365 and the content player 610. The content player 610 is communicatively coupled to the content delivery server 330 and the CMS 410. The platform 365 is communicatively coupled to the content delivery server 330, the client apparatus 605, and the content player 610. The platform 365 and the content player 610 may communicate with the content delivery server 365 by making requests to the API 350 and receiving communications from the API 350. In some embodiments, the platform 365 may also utilize an API for communication with the content player 610 and the client apparatus 605.

The client apparatus 605 loads the content player 625 after the client apparatus 605 is instructed to visit a particular website that hosts the content player. The client apparatus 605 may communicate with the platform 365 to download an instance of the content player 415 to the client apparatus 605. In some embodiments, the instance of the content player 415 is a copy of an executable version of the content player, which may include additional third party feature that are compiled into the copy. As discussed above, the client apparatus 605 may communicate an event ID to the platform 365 in order to receive the appropriate content stream(s) for presentation at a display. The platform 365 will use the event ID to derive a URL indicating where the content stream(s) may be located on the content delivery server 330 by making a request to the API 350. The content delivery server 330 may then communicate the appropriate content streams through the API 350 to the platform 365. The platform 365 ultimately communicates the content stream(s) to the content player 625. In some embodiments, the content stream(s) may be part of an event having several different camera feeds captured as content streams, each presentable to a display by the player 625.

In another embodiment of the content distribution system, the content player 630 may be embedded in a remote website provided through the remote host 615. For example, the presented content may be a sporting event that a remote sports channel with a website may wish to display on its own website. In such cases, when the sports website is accessed on the client apparatus 620, the client apparatus 620 may make a request to download the embedded content player. Since the embedded content player 630 is located at a webpage served by a remote host, client apparatus 620 may communicate the request with an event id through the remote host 615 to the content player 610. The content player 610 will then communicate with the CMS 410 to retrieve the URL of the event and/or associated content streams in the content distribution system 330. The content player 610 will then use the URL information to make a request through the API 350 to the content delivery server 330 to retrieve the content stream(s). The content player 610 will then serve an instance of the content player as embedded content player 630 to the client apparatus 620. The embedded content player 630 may present the content stream(s) downloaded from the content delivery server 330 to the display.

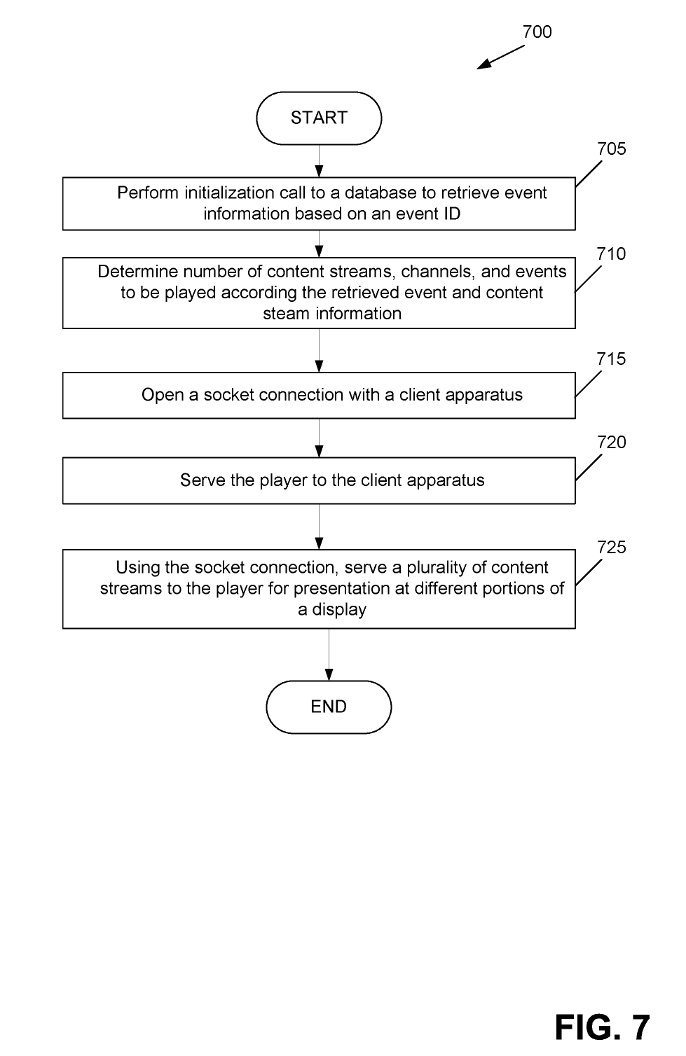

FIG. 7 conceptually illustrates a process 700 for serving content stream(s) to a client apparatus. The process 700 may be performed by a server apparatus such as the platform 365. The process 700 may begin after receiving a request from a client apparatus to initialize a content player on the client apparatus. The request may be communicated to the server apparatus via an API.

As shown, the process 700 performs (at 705) an initialization call to a database to retrieve event information based on an event ID. Such an initialization call may be made to the CMS 410 to retrieve the event information and associated content stream locations(s) from the database 405 described in FIG. 4. The process 700 determines (at 710) a number of content streams, channels, and events to be played according to the retrieved event and content stream information. Typically, each content stream is associated with an event. Oftentimes more than one content stream will be associated with an event such as the sporting event example discussed above. However, it may be possible to download several different events having several different content streams or several different channels having several different content streams at the same event. Such an option will be discussed in more detail in the foregoing.

At 715, the process 700 opens a socket connection with a client apparatus. A socket connection may be described as a socket pair in that it defines the two end points of the connection. A client apparatus and a server apparatus may establish multiple socket connections with different apparatuses. However, each connection must be unique to the client apparatus or the server apparatus. Therefore, each socket connection is defined by the following four-tuple:

local_address, local_port, remote_address, remote port

where the local_address is an IP address of the local device the open socket, the local_port is the port number of the local device, the remote_address is the IP address of the other end of the socket connection, and the remote_port is the port number of the other end of the socket connection. From the perspective of the client apparatus, the local device refers to the client apparatus, while from the perspective of the server apparatus, the local device refers to the server apparatus. In some embodiments, the server apparatus may be a web server capable of receiving HTTP, HTTPS, and/or FTP communication. Several different socket types are available including datagram sockets, which use a UDP protocol, stream sockets, which use a TCP or SCTP protocol. In the case of a client/web server connection, typically a TCP socket is first established. However, other socket types may be established depending on the implementation of the client and/or server architecture.

Typically the web server will use a remote_port number 80. Upon start up, a web server, such as an HTTP server may open a socket at local_address 80. This socket may initialize to a listening state. Specifically, since a client apparatus knows that web servers wait for communication on port 80, the client apparatus is able to request a socket connection by simply knowing the IP address of the web server. However, the client apparatus may transmit a URL, which is translated by a DNS server to an IP address and the connection to the web server can then be made. For instance, the client apparatus may make a socket connection by establishing a TCP session with the server apparatus using the client's IP address and a random port number, typically assigned by the client apparatus' operating system. Once the session is established, the socket connection is made based on the unique four-tuple. Since the server apparatus will typically have the same IP address and port number (80), the connection is unique due to the client's IP address and randomly assigned port number. For instance, a unique four-tuple socket connection may appear as:

(157.16.0.1, 80, 172.0.0.8, 68734)

where the 257.16.0.1, 80 is the server apparatus socket (e.g., IP address and port number) and 172.0.0.8, 68734 is the client apparatus socket (e.g., IP address and port number). Since each client apparatus that may establish a connection with the same server apparatus will have a different IP address and multiple sockets connections from the same client apparatus will use different ports for each connection, the socket pair will always be unique to the server apparatus. Thus, the server apparatus will be able to communicate the right information over the appropriate socket without any conflicts.

Once the socket connection is established, the process 700 may then serve (at 720) the content player to the client apparatus through the socket connection. The process 700 then, using the socket connection serves (at 725) a plurality of content streams to the content player for presentation at different portions of a display on the client apparatus.

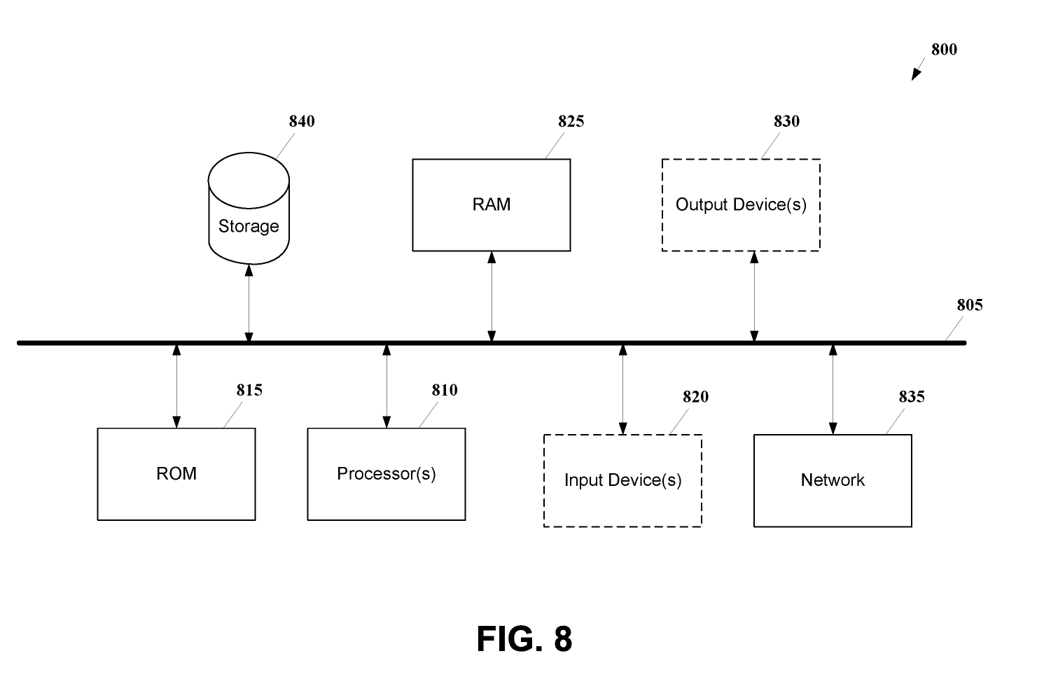

FIG. 8 illustrates a schematic representation of an exemplary embodiment of a client apparatus or a server apparatus. The apparatus 800 may be a client apparatus, such as the client apparatuses 605 and/or 620. Alternatively or conjunctively, the apparatus 800 may be a server apparatus such as the platform 365. The apparatus 800 includes various types of processors, machine readable media and interfaces. The server apparatus 800 includes a bus 805, processor(s) 810, read only memory (ROM) 815, random access memory (RAM) 825, a network component 835, and a permanent storage device 840. The client apparatus may additionally include input device(s) 820 and output device(s) 830.

The bus 805 communicatively connects the internal devices and/or components of the apparatus 800. For instance, the bus 805 communicatively connects the processor(s) 810 with the ROM 815, the RAM 825, and the permanent storage 840. The processor(s) 810 retrieve instructions from the memory units to execute processes of the apparatus 800. For instance, the processor(s) 810 of the client apparatus may retrieve instructions on how a plurality of content streams are to be presented to a display and execute such instructions. The processor(s) 810 may also retrieve instructions on how to resize, move, select, and/or eliminate one of several content streams presented to a display. The processor(s) 810 of the server apparatus may execute instructions for establishing network socket connections with the client apparatus, serving the content player to the client apparatus, and storing and serving data associated with how to access the content streams.

The processor(s) 810 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions or code recorded on a machine readable storage medium (also referred to as machine readable media). When these instructions are executed by one or more of the processor(s) 810, they cause the processor(s) 810 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 810. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor and are executable to perform various operations. Examples of computer include machine code, such as is produced by a compiler, and files including higher level code that are executed by a computer or a microprocessor using an interpreter. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, the machine-readable media may comprise non-transitory machine-readable media (e.g., tangible media) as described. Alternatively, or in addition to, the machine-readable media may comprise transitory machine-readable media (e.g., a transmission cable, a carrier-wave, etc.). Combinations of the above should also be included within the scope of machine-readable media.

The ROM 815 stores static instructions needed by the processor(s) 810 and other components of the apparatus 800. The ROM may store the instructions necessary for the processor(s) 810 to execute the processes provided by the apparatus 800. The permanent storage 840 is a non-volatile machine readable media that stores instructions and data when the apparatus 800 is on or off. The permanent storage 840 is a read/write machine readable medium, such as a hard disk or a flash drive. The RAM 825 is a volatile read/write machine readable medium. The RAM 825 stores instructions needed by the processor(s) 810 at runtime, the RAM 825 may also store buffered content streams on the client apparatus.

The bus 805 also connects input and output devices 820 and 830, which may be included on the client apparatus. The input devices enable the user to communicate information and select commands to the apparatus 800. The input devices 820 may be a keypad, keyboard, cursor control device, and/or touch screen display capable of receiving touch interactions. The output device(s) 830 display images generated by the apparatus 800. The output devices may include printers, display devices such as monitors, and/or speakers. The processor(s) 810 on the client apparatus may execute instructions controlling how an output device 830 such as a display is to present and modify the presentation of the video of several different content streams. The processor(s) 810 on the client apparatus may also execute instructions controlling the audio from which a content stream may be presented to a speaker.

The bus 805 also couples the apparatus 800 to a network 835. The apparatus 800 may be part of a local area network (LAN), a wide area network (WAN), the Internet, a satellite feed, or an Intranet by using a network interface. In the case of a client apparatus, the apparatus 800 may be a mobile apparatus that is connected to a mobile data network supplied by a wireless carrier. Such networks may include 3G, HSPA, EVDO, and/or LTE. The server and/or wireless client apparatuses may transmit content streams across the network using HTTP or TCP over any one of the network protocols above.

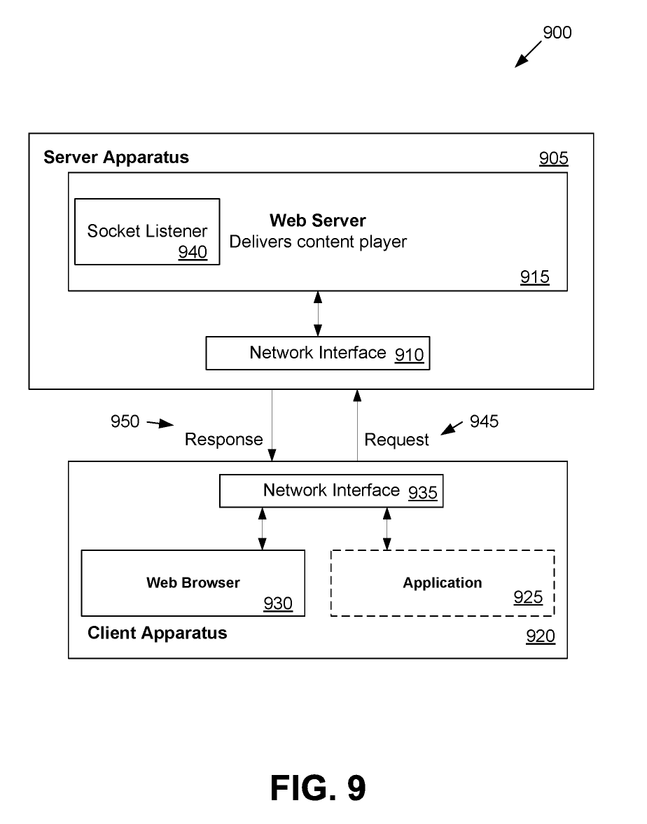

FIG. 9 illustrates an exemplary embodiment of a client/server architecture 900 for serving a content player from a server apparatus 905 to a client apparatus 920. The client/server architecture includes a server apparatus 905, a client apparatus 920, a request 945, and a response 950. The server apparatus 905 includes a web server 915 and a network interface 910. The web server 915 includes a socket listener 940. The client apparatus 920 includes a network interface 935, a web browser 930, and optionally an application 925 programmed to request the content player. In some embodiments, the server apparatus 905 is the platform 365, while in other embodiments the server apparatus 905 is a server that resides on the remote host 615.

In some embodiments, the client apparatus 920 is a laptop computer, a desktop computer, a smartphone, a tablet, or any other device capable of accessing the internet through the web browser 930 or the application 925. The server apparatus 905 and the server apparatus 920 comprise the hardware elements as discussed above in FIG. 9. For instance, the client apparatus 920 may receive user input from the input device(s) 820 to open the web browser and access a particular website. The web browser may receive user input of a URL that is associated with the server apparatus 905. The web browser 930 will then transmit a request 945 through the network interface 935. The request 945 may be sent over the Internet where a DNS server derives the IP address associated with the server apparatus 905 from the received URL. The request 945 is then received by the network interface 910 on the server apparatus 905. The network interface 910 may then forward the request to the web server 915.

The web server 915 maintains a socket listener 940, typically on port 80. The purpose of the socket listener 940 is to listen for socket connection requests. The request 945 may a socket connection request sent using a protocol such as HTTP, or at a lower level, TCP. The socket listener 940 may then open a socket connect, as discussed above (See FIG. 7) between the web server 915 and the web browser 930.

The web server may store the content player or be capable of accessing the content player from a file server that maintains the content player. The content player is the served to the web browser as the response 950 via the established socket connection. More specifically, the server apparatus 905 may establish a socket connection between the network interface 910 and the network interface 935 such that the server apparatus 905 and the client apparatus 920 may communicate over a single socket connection. Once the content player is downloaded by the web browser 930, the content player may then download the content for presentation on the display (e.g., output device(s) 930).

As discussed above with respect to FIG. 6, the content player may be downloaded to a web browser and presented to a display or the content player may be presented to a display within an IFrame of an HTML document. In such cases, the Web server 915 may deliver the HTML page along with the content player using the established socket connection between the network interfaces 910 and 935.

Optionally, the client apparatus 920 may include the installed application 925 and/or a plug-in. The application 925 may be executed by receiving user input at the client apparatus 920. Upon execution, the application 925 may make a similar request 945 over the network interface 935 to the network interface 910 on the server apparatus. The content player will then be served from the server apparatus 905 in the same manner discussed above with respect to the web browser 930. A mobile apparatus such as a smartphone or tablet are exemplary client apparatuses that may include the application 925.

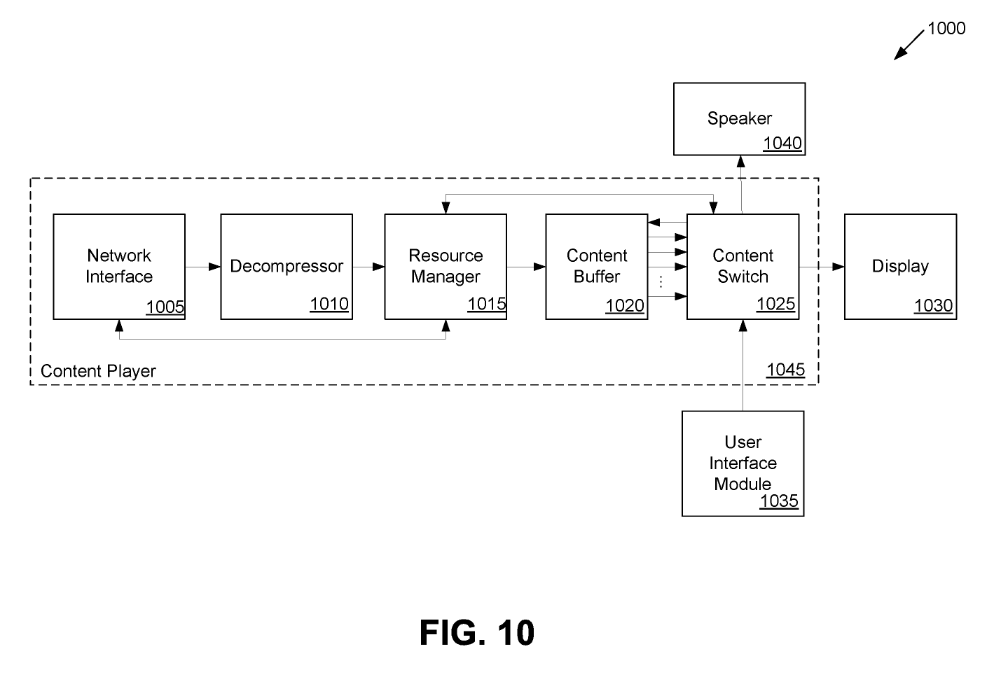

FIG. 10 illustrates a functional block diagram of an exemplary embodiment of a client apparatus. The functional diagram may represent software and hardware modules. All software modules are implemented on the hardware described above in FIG. 8.

As illustrated in FIG. 10, the apparatus 1000 a content player 1045, a display 1030, a speaker 1040, and a user interface module 1035. The content player 1045 includes a network interface 1005, a decompressor 1010, a resource manager 1015, a content buffer 1020, and a content switch 1025. The content player 1045 is downloaded from a server apparatus over a network interface. The content player 1045 is configured to be downloaded via an interface from the server apparatus and to operate on the client apparatus.

The network interface 1005 is communicatively coupled to the decompressor 1010 and may provide a communication link with a server apparatus, such as the platform 365. The network interface 1005 establishes a socket connection with the server apparatus such as the server apparatus 905 (See FIG. 9).

The network interface 1005 passes received data packets comprising the content streams to the decompressor 1010. The content streams may be received at the network interface 1005 through a single socket connection established between the client apparatus and the server apparatus. The decompressor 1010 is communicatively coupled to the resource manager 1015. The decompressor unpacks the data packet into the content stream(s) and may perform other functions such as reordering data packets if they are received out of order from the network interface depending on the transmission protocol used for transmitting data packets. For instance, if the data packet is delivered by way of a Real Time Streaming Protocol (RTSP), the socket connection between the content player and the server may be maintained by way of a TCP connection and thus, each packet may include information regarding the order in which the data packets should be received. In such instances, data packets received out of order may be reordered at the decompressor 1010. As those skilled in the art will appreciate, RTSP is an application layer protocol, while TCP is a transport layer protocol according to the Internet Protocol Suite. The application layer includes the protocols used by most applications for providing user services or exchanging application data over the network connections established by the lower level protocols such as the transport layer. Therefore, the content streams may be provided using RTSP over a single TCP socket connection. Additionally, those skilled in the art will appreciate that the data packet transmission at the application layer is not confined to the RTSP protocol. Any suitable protocol may be utilized such as Real-time Transport Protocol (RTP) in conjunction with Real-time Control Protocol (RTCP) or any proprietary protocol for streaming live or recorded content.

The unpacked content streams may be encoded in a compressed format such as MPEG2, MPEG4, HLS, HDS, and/or any other suitable multimedia content format. The decompressor 1010 also performs the function of decoding the encoded content streams so that they are capable of being presented at the display 1030.

The decompressed data packets comprising content streams are then communicated to the resource manager 1015. The resource manager 1015 is communicatively coupled to the network interface 1005, the content buffer 1020, and the content switch 1025. The resource manager 1015 performs the function of determining the hardware resources that may be required to properly present the content streams to the display in a suitable manner and whether the client apparatus has such resources available. For instance, the resource manager may determine how to allocate the memory and processor resources such as how threads will be allocated in a single core processor, a multi-core processor, and/or a multiprocessor environment. The resource manager 1015 may retrieve the client apparatus' available resources through API calls the client apparatus' operating system. The resource manager 1015 may periodically make such calls and make adjustments to the allocation of resources based on the resources available at the time. Additionally, the resource manager 1015 may receive periodic feedback from the content switch 1025 regarding how the content streams are being presented at the display. Based on the display presentation and the available resources at the time, the resource manager will coordinate and make adjustments to the computing resources to ensure an optimal viewing experience.

The resource manager 1015 may also communicate with the network interface 1005 when it determines that the available resources cannot support the type of content that is being served from the content delivery server 330. In such cases, the resource manager 1015 will communicate a request through the network interface 1005 to the content delivery server 330 using the API 350 to adjust the manner in which the content streams are being served. When hardware resources free up again and/or the presentation of the content streams at the display has changed, the resource manager 1015 may communicate another request through the API 350 to the content delivery server 330 via the network interface 1005 to again adjust the manner in which the content streams are being served.

The resource manager 1015 will then communicate the unpacked content streams to the content buffer 1020. The content buffer 1020 provides the ability to perform different functions on the presented content such as rewind, pause, and fast forward. The content buffer 1020 also provides the added benefit of avoiding interruptions in the presentation when the content streams are interrupted on the network. As discussed above, the resource manger 1015 may also communicate resource allocation information to the content switch 1025. The content buffer 1020 may communicate any number of n streams to the content switch 1025. The content switch 1025 is communicatively coupled to the display 1030, the speaker 1040, and the content buffer 1025. The content switch 1025, which will be discussed in greater detail in the description of the following figure, provides fully configurable control of the display 1030. For instance, the content switch 1025 grants the user access to perform a number of functions on the content streams presented to the display 1030. Such functions include moving content streams, selecting audio from a content stream, eliminating a content stream, selecting/restoring a content stream, and/or changing how the content streams are viewed (e.g., in a grid or PiP).

The user interface module 1035 is communicatively coupled to the content switch 1025. The user interface module 1035 may receive user input from any suitable control device including, but not limited to, a cursor control device, a keyboard, touch screen, and/or a stylus. The user input received at the user input module 1035 is communicated to the content switch 1025 and determines how the streams are to be presented at the display 1030. In some instances, when the resource manager 1015 determines that the client apparatus has adequate resources and coordinates the resources to provide an HD presentation of the content streams at the display 1030. When the resource manager determines that adequate resources are available, the content stream(s) communicated to the display 1030 will be of a HD quality.

The content player is also capable of switching between different channels. Each channel may represent a different event or different area of an event. For example, a music festival may have several different stages, each with different performances. In this example, each stage may be associated with a different channel and each channel may comprise several camera feeds. The content delivery apparatus converts the camera feeds for each channel to content streams as discussed above. In some embodiments, the content buffer 1020 may only buffer the content streams associated with a single channel until instructed to switch channels by the content switch 1025. Upon receiving the instructions to switch to a new channel from the content switch 1025, the content buffer 1020 may begin buffering at least one new content stream associated with the new channel.

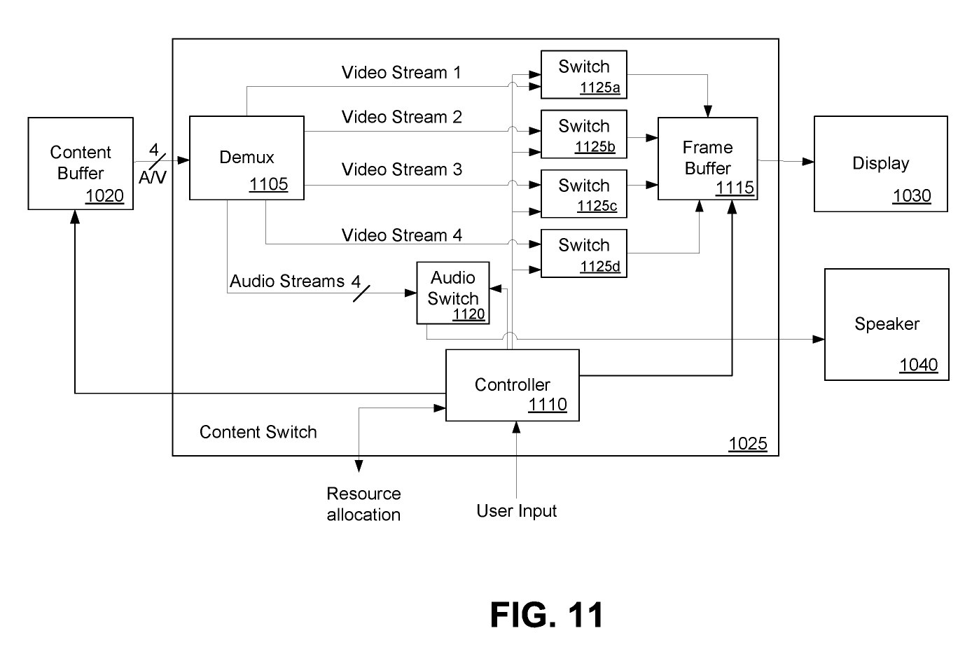

FIG. 11 illustrates a functional block diagram of an exemplary embodiment of a configuration of the content switch 1025. The content switch 1025 grants a user the ability to assign configurable display portions that are configurable in response to user interactions with each display portion. In some embodiments, a video stream is attached to a surface that covers a portion of the display. In the following sections, a display portion will be referenced as a surface with the understanding that these terms may be used interchangeably throughout.

The surface presents the video stream to the display 1030. The surface is also fully configurable. For instance, the surface may be resized, moved, and/or removed. Thus, any reference to the surface in the foregoing implies that any function performed on the surface affects the presentation of the video stream. Furthermore, data about the surface such as pixel location, size, and/or content may be maintained in the RAM 825 for as long as the surface remains attached to a content stream.

As shown, FIG. 11 includes the content buffer 1020, the display 1030, and the speaker 1040, all described with respect to FIG. 10. FIG. 11 also includes the content switch 1025. The content switch 1025 receives content stream(s) from the content buffer 1020 and outputs a configurable presentation of the content stream(s) to the display 1030 and audio to the speaker 1040.

The content switch 1025 includes a demux (or demultiplexer) 1105, an audio switch 1120, a controller 1110, switches 1125a-1125d, and a frame buffer 1115. As illustrated, the controller 1110 receives user input and resource allocation and coordination data. In this exemplary embodiment of the content switch 1025, the demux 1105 receives four content streams from the content buffer 1020. The demux 1105 is communicatively coupled to the switches 1125a-1125d, and the audio switch 1120. The demux 1105 demultiplexes the content streams received from the content buffer 1020 and places each stream on a separate bus channel. In this exemplary embodiment of the content switch, the separate bus channels carry video streams 1, 2, 3, and 4. The audio streams are also demultiplexed from the content streams and all 4 audio streams are placed on an additional bus channel.

Based on the received user input, the controller 1110 communicates the appropriate signals to the audio switch 1120, the switches 1125a-1125d, the content buffer 1030, and the frame buffer 1115. Additionally, based on received user input to switch to a new channel, the controller 1110 may transmit a signal the content buffer 1020 to begin buffering at least one new content stream corresponding to the new channel. As will be discussed below, the based on received user input, the controller 1110 may transmit a signal to the frame buffer 1115 for how to present the configurable surfaces at the display 1030 according to received user input.

The controller 1110 may receive user input selecting the number of video stream(s) 1 through 4 to present at the display 1030 and an audio stream to output to the speaker 1040. For instance, the controller 1110 may receive user input selecting video streams 2, 3, and 4. In such instances, the controller 1110 will enable the switches 1125b-1125d, while disabling switch 1125a. If the controller 1110 receives subsequent user input to eliminate the video stream 2, then the controller 1110 will disable the switch 1125b, while the switch 1125a remains disabled, and the switches 1125c-1125d remain enabled. Only the video streams corresponding to the enabled switches will be communicated across the corresponding bus channel to the frame buffer 1115. The controller 1110 will then attach a surface to each communicated stream and determine how the surfaces are presented at the display 1030. Furthermore, when a switch changes from an enabled to disabled state, the corresponding content stream will no longer be communicated to the frame buffer 1115, and the previously attached surface will be cleared from memory. However, when a switch changes from a disabled to an enabled state, the corresponding video stream will be communicated to the frame buffer 1115 and a new surface will attach to the new stream.

The audio switch 1120 receives user input to select an audio stream. The selected audio stream may then be played through the speaker 1040. In some embodiments, the controller 1110 may receive user input to switch audio streams. In such instances, the audio switch 1025 will select a new audio stream based on the user input to be played at the speaker 1040. In some embodiments, the controller 1110 may automatically transmit a signal to the audio switch to either change audio streams or cease all audio playback.

According to the user input, the controller 1110 will communicate signals to the frame buffer 1115 for how the selected video streams are to be presented at the display 1030. The frame buffer is a portion of the RAM 825 comprising a bitmap that is driven to a display. The frame buffer comprises a complete frame of video data. The video data typically comprises color values for every pixel on a display and/or alpha channels that define the transparency of each pixel.

In some embodiments of the switch, each of the selected video streams is attached to the surface discussed above and each surface is assigned a group of pixels by the frame buffer 1115. In some cases, such as PiP mode, a group of pixels assigned to a first surface may be a subset of a larger group of pixels assigned to a second surface. The surface is fully adjustable based on the user input received at the controller 1110. The location and size of the surface may be defined by an [x,y] coordinate on the display associated with the top, right corner of the location of the surface presented to the display and a size of the surface. The controller 1110 may derive the group of pixels occupied by each surface based on the [x,y] coordinate and size information. For instance, the controller 1110 may receive information relating to the aspect ratio of the content (e.g., 16:9, 4:3, or 2.35:1) from the resource manager 1015 or another module capable of recovering the display format and communicating the format to the controller 1110. Based on the size and the aspect ratio, the controller 1110 may generate a matrix of a size N×Z where N represents the number of horizontal pixels in the surface and Z represents the number of vertical pixels in the surface. Each index in the matrix identifies a pixel value on the display. For instance, each pixel on a display may have a single numerical value derived by counting the pixels from left to right cumulatively for each row of pixels. Index (1,1) of the matrix will comprise the pixel associated with the provided [x,y] coordinate. The rest of the indices will correspond to the rest of the pixels covered by the surface associated with the content stream.

By way of example, if the content switch receives an [x,y] pixel coordinate of [1,1], a display format of 4:3 and a size of 12 pixels, a representative matrix may be 4×3 with the following values, assuming the display resolution is 1920×1080:

$$( \begin{matrix}1 & 2 & 3 & 4 \\ 1921 & 1922 & 1923 & 1924 \\ 3841 & 3842 & 3843 & 3844\end{matrix} )$$

As discussed above, the content switch 1025 also has the capability to present at least two content streams in PiP format when such user input is received. In such instances, a pixel matrix may be derived for the first content stream surface and another pixel matrix may be derived for the second content stream surface. Except in this instance, the second content stream matrix shares all of its pixels with a subset of the pixels of the first content stream matrix. In such instances, the controller 1110 will recognize the overlap and instruct the frame buffer 1115 to black out those overlapping pixels for the first content stream surface. Then the controller 1110 will instruct the frame buffer 1115 to fill the black space with the second content stream surface.

In some embodiments, controller 1110 will recognize when two pixel matrices of different sizes are being processed in order to present the content streams to the display. The controller 1110 may then analyze the smaller matrix to locate any pixels that overlap with the larger matrix. When such overlapping pixels are detected, the controller 1110 will instruct the frame buffer 1115 to black out those pixels for the content stream associated with the larger matrix and present the content stream associated with the smaller matrix in the black space to the display. In some embodiments the controller 1110 will generate a third matrix that is the size of the larger matrix. Each index is associated with the pixel value at the same index in the larger matrix. Therefore, for each index in the third matrix associated with a pixel value in the first matrix that is not included in the second matrix, the controller 1110 will assign a 1 and for those indices that are associated with pixel values in the first matrix that are also present in the second matrix, the controller 1110 will assign a 0. Those indices that are assigned a 0 represent pixels that will only present the smaller content stream (e.g., the content stream associated with the second matrix). Utilizing the three matrices, the controller 1110 will instruct the frame buffer to prepare the content streams for presentation to the display accordingly.

Moreover, the content switch 1025 may receive user input to present the content streams in a grid mode. In such instances, a matrix will be generated for each content stream to be presented. Here, one matrix will comprise pixel values at the edge that are adjacent to an opposite edge of pixel values comprised in another matrix. However, no pixel values will be the same. Based on the aspect ratio and display size, the controller 1110 will be able to determine the top, right most [x,y] coordinate for each surface to be presented as well as the size. The matrices for each surface will be generated accordingly, such that each surface will be presented adjacent to another surface.

The frame buffer 1115 presents at least two uniquely controllable surfaces to the display 1030 based on the user input received at the controller 1110. For instance, the controller 1110 may receive user input to resize one of the uniquely controllable surfaces. In such instances, the controller may receive user input by way of a click and drag interaction with the surface. Once the click and drag action is complete, the resized surface will be associated with a new [x,y] coordinate for the top, rightmost pixel of the surface and a new size. However, depending on how the surface is resized, the [x,y] coordinate may remain the same. Conversely or conjunctively, the controller 1110 may, for instance, receive user input to move a surface. In such instances, the controller 1110 may receive a similar click and drag interaction. Such an interaction may yield a new [x,y] coordinate for the top, right most pixel of the surface, but the size would remain the same. The controller 1110 may also receive user input to eliminate a surface from view. In such instances, the surface will not be associated with any [x,y] pixel coordinates or a size, and one of the switches 1125a-1125d will be disabled as discussed above.

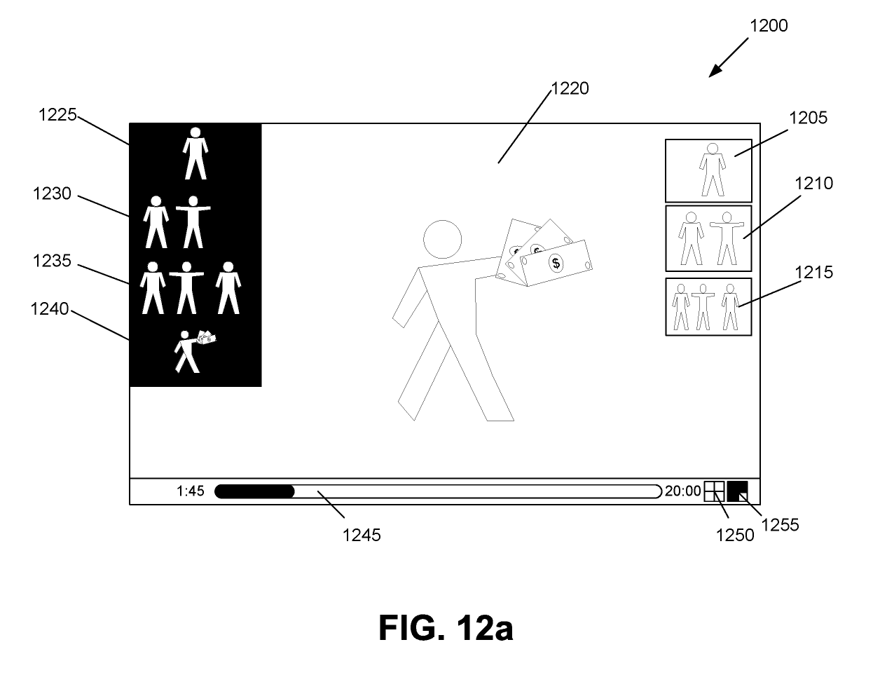

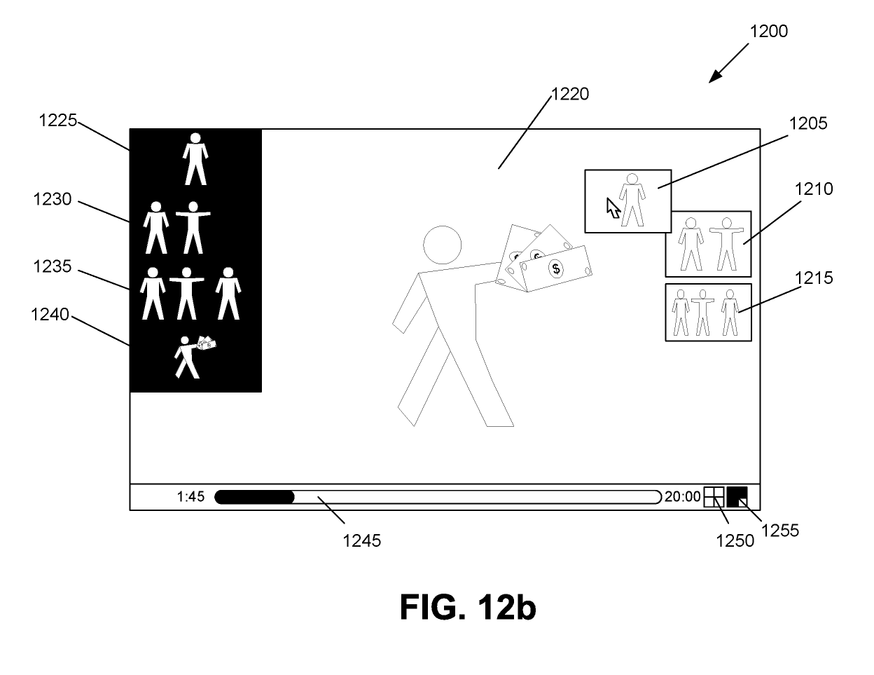

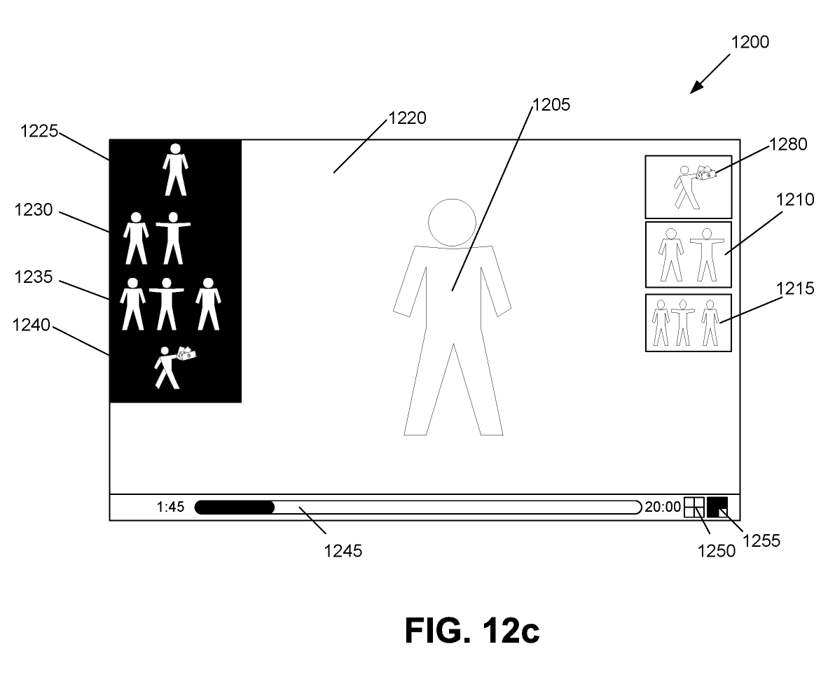

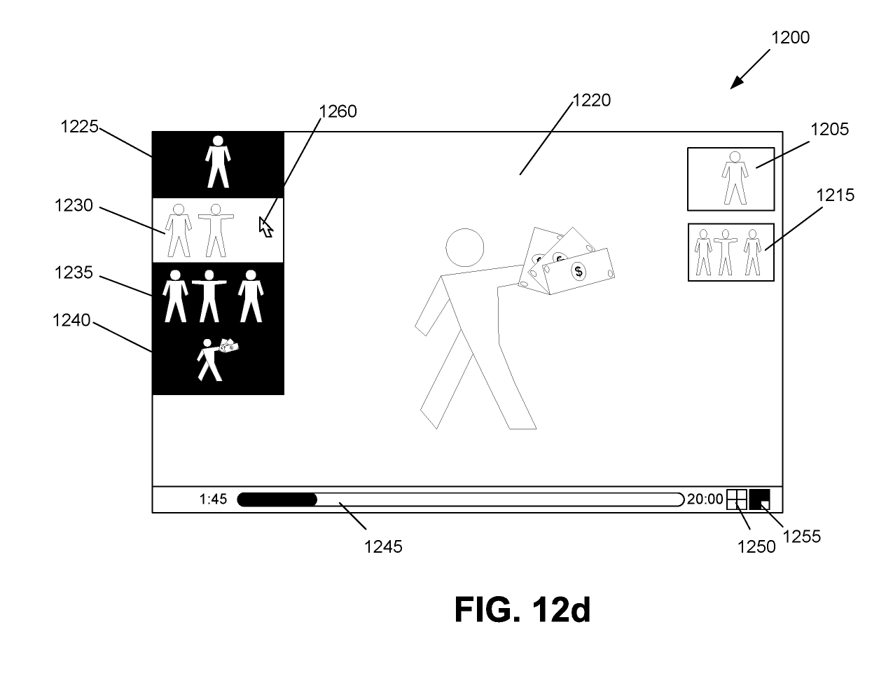

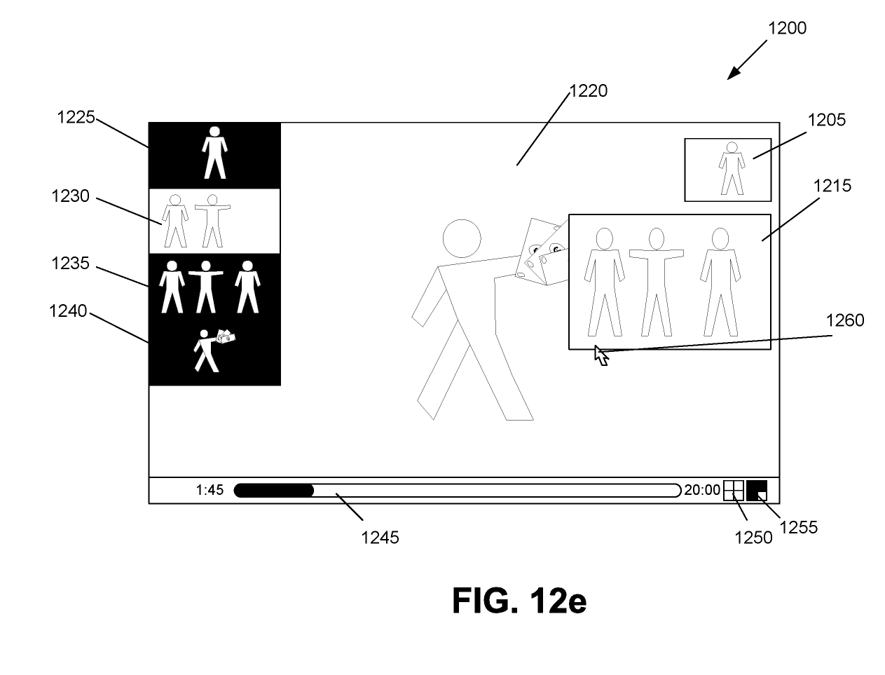

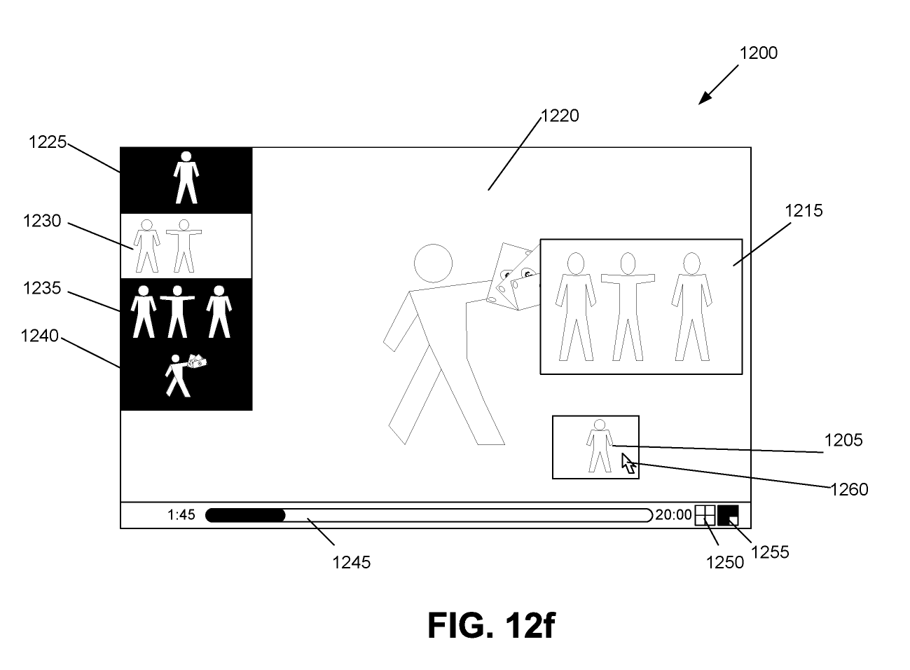

FIGS. 12a-12f illustrate a variety of exemplary content stream presentations on a display in response to user interactions with a display 1200. As described above, each video stream is attached to a surface and a user may interact with the surface by way of a click and drag interaction using a cursor control device or a gestural interaction at a pixel location within the surface. Furthermore, each interaction received at the display 1200 is processed by the controller 1110.

FIG. 12a illustrates an exemplary embodiment of the display 1200 in PiP mode. The display 1200 includes a display area 1220, content stream representations 1225-1240, PiP content streams 1205-1215, timeline 1245, and selectable objects 1250 and 1255. Many of the features in the display 1200 are similar to the features illustrated in FIG. 1. For instance, the content stream representations 1225-1240 are similar to content stream representations 125-140, the timeline 1245 is similar to the timeline 115, and selectable objects 1250 and 1255 are similar to selectable objects 110 and 115. The same description of these features in FIG. 1 applies to FIGS. 12a-12f.

The display 1200 may be presented after the content delivery server received a request to serve an instance of the content player 625 or 630 to the client apparatus 605 or 620 (see FIG. 6). In the exemplary illustration shown in FIG. 12a all content stream representations 1225-1240 have been selected. Additionally, the selectable object 1255 has also been selected indicating that the display 1200 is configured to present the content streams in PiP mode. As shown, a content stream associated with the content stream representation 1240 is presented in the display area 1220. Additionally, the PiP content streams 1205-1215 are also presented in the display area 1220, but in a smaller size such that it is possible to view all of the content streams in a manner that provides an enjoyable user experience.

FIG. 12b illustrates the display 1200 while a user interaction is occurring on the surface of PiP content stream 1205. In this exemplary illustration, the surface associated with the PiP 1205 is experiencing a click and drag interaction from a cursor control device. In such interactions, the PiP content stream 1205 may move to a new location in the display area 1220. As such, the PiP content stream 1205 will be associated with a new group of pixels derived as discussed in detail with respect to FIG. 11 that represent the PiP content stream's 1205 surface. Alternatively, the PiP content stream 1205 may replace the content stream in the display area 1220. Additionally, content stream in the display area may be associated with a new group of pixels that is presented and a new group of pixels that is blacked out.

As shown in FIG. 12c, the user interaction has caused the PiP content stream 1205 to swap locations with the content stream previously presented in the display area 1220. As such, the content stream previously presented in the display 1220 has moved to the previous location of the PiP content stream 1205 and is now PiP content stream 1280. Thus, the swapped content streams are now associated with new groups of pixels.

FIG. 12d illustrates an exemplary embodiment of an interaction with the display 1200. In this exemplary embodiment, the content stream representation 1230 has received user input by way of a cursor 1260 to deselect the content stream representation 1230. As such, the PiP content stream 1210 has been eliminated from the display area 1220. Thus, the PiP content stream's 1210 surface is no longer associated with any pixel group.

FIG. 12e illustrates an exemplary embodiment of an interaction with the display area 1200 to resize the PiP content stream 1215. Such an interaction may be a click and drag interaction received from a cursor control device as represented by the cursor 1260. However, in some embodiments, a gestural interaction may also cause the same re-size operation. As illustrated, the surface of the PiP content stream 1215 is receiving a user interaction at the edge of the PiP content stream 1215 as opposed to FIG. 12b where the cursor was located within the surface of the PiP content stream 1215. As such, the PiP content stream 1215 now takes up additional pixel space in the display area 1220 and is correspondingly associated with a new group of pixels. Additionally the content switch 1025 will increase the blacked out pixels of the content stream presented in the display area 1220 accordingly and the PiP content stream 1215 will cover the blacked out pixels.

FIG. 12f illustrates an exemplary embodiment of the fully configurable display 1200. As shown, 3 content streams are presented at the display 1200 in PiP mode. The surface of the PiP content stream 1215 previously received a user interaction to increase the size of the surface. Now, the surface of the PiP content stream 1205 is receiving a user interaction from the cursor 1260 to move the PiP content stream 1205 to a new location. Thus, the PiP content stream 1205 remains the same size, but is associated with a new group of pixels due to the change in location in the display 1200.

Although FIGS. 12a-12f illustrate exemplary ways to customize the display 1200, the customizability is not confined to only these examples. For instance, the PiP content streams may be resized and/or moved to any location within the display 1200. Additionally, the content stream representations may be selected in any number of ways such as a drag and drop interaction, a tapping or dragging gestural interaction, or receiving a selection from a cursor control device. As will be discussed in the following figures, the display 1200 may switch between grid mode and PiP mode.

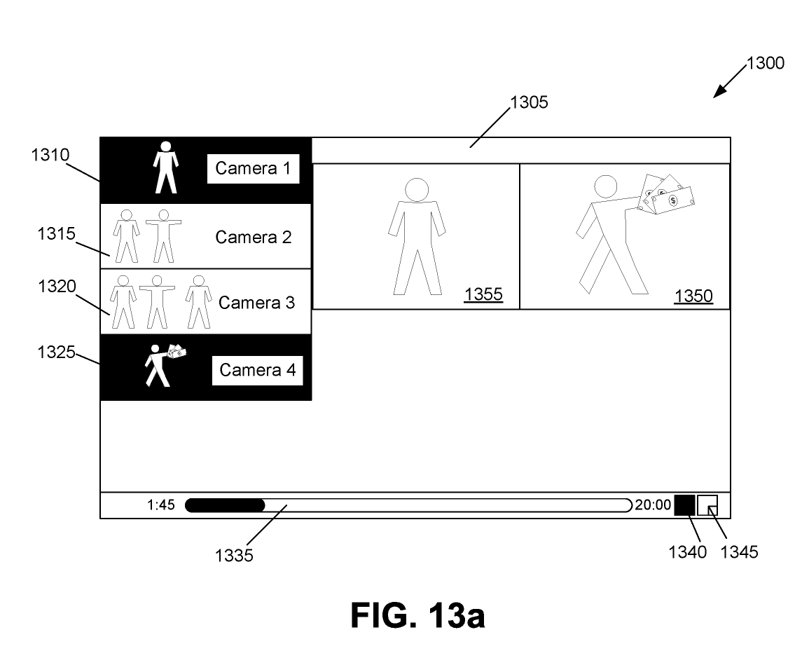

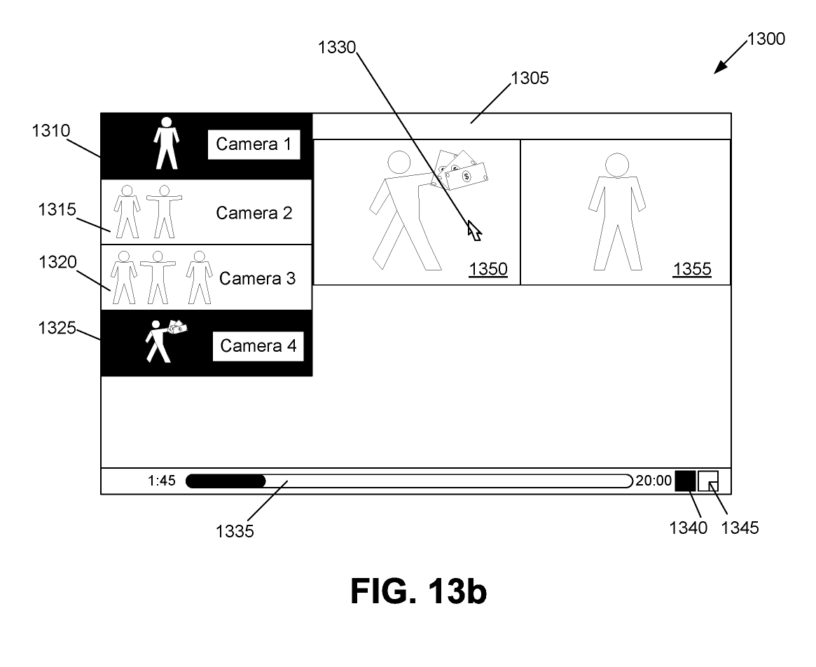

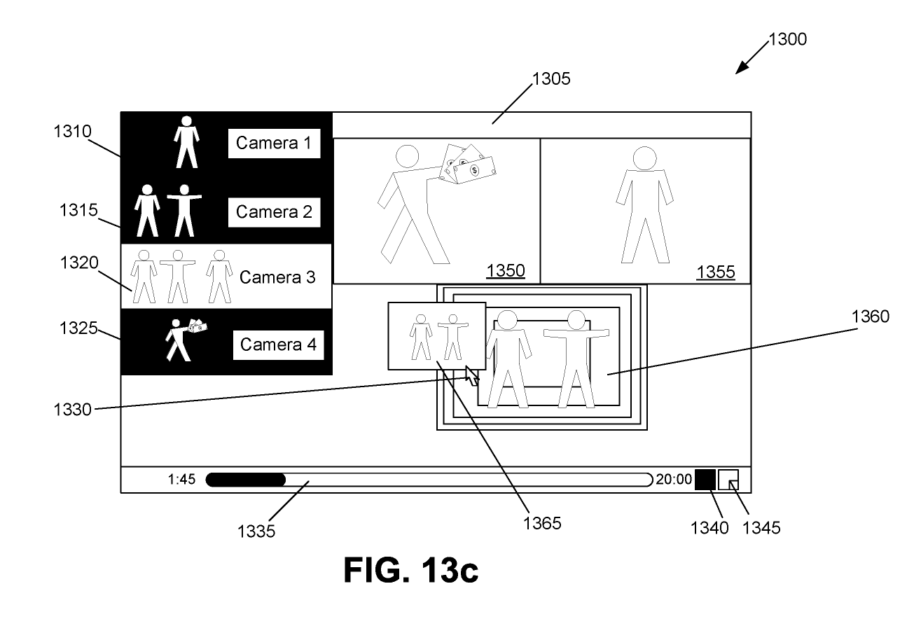

FIGS. 13a-13c illustrate an exemplary embodiment of a display 1300 in grid mode. As described above, each video stream is attached to a surface and a user may interact with the surface by way of a click and drag interaction using a cursor control device or a gestural interaction at a pixel location within the surface. Furthermore, each interaction received at the display 1300 is processed by the controller 1110.

FIG. 13a illustrates an exemplary embodiment of the display 1300 in grid mode. The display 1300 includes a display area 1305, content stream representations 1310-1325, content streams 1355 and 1350, timeline 1335, and selectable objects 1340 and 1345. Many of the features in the display 1300 are similar to the features illustrated in FIG. 1. For instance, the content stream representations 1310-1325 are similar to content stream representations 125-140, the timeline 1335 is similar to the timeline 115, and selectable objects 1340 and 1345 are similar to selectable objects 110 and 115. The same description of these features in FIG. 1 applies to FIGS. 13a-13c.

The display 1300 may be presented after the content delivery server received a request to serve an instance of the content player 625 or 630 to the client apparatus 605 or 620 (see FIG. 6). In some embodiments, grid mode may be the initial default mode for which content streams are presented. As illustrated in FIG. 13a, two content streams 1355 and 1350 are displayed in a grid in the display area 1305. As is also shown, the selectable object 1340 is selected, indicating that the display 1300 is currently operating in grid mode. In grid mode, a subset of the customizable features described with respect to PiP mode may be available.

For instance, FIG. 13b illustrates the display 1300 receiving a user interaction with one of the content streams. As shown, the user has initiated an interaction to swap the locations of the presented content streams 1350 and 1355. Such an interaction is illustrated in the display 1300 by receiving an interaction with a cursor control device associated with the cursor 1330 to drag and drop the presented content stream 1350 in place of the presented content stream 1355. In some embodiments, once the content stream 1350 is dragged over the content stream 1355, the content stream 1355 may automatically switch locations. Once the swap is complete, the content streams 1350 and 1355 are associated with a new group of pixels based on the new locations of the presented content streams in the display 1300.

FIG. 13c illustrates another exemplary interaction with the display 1300. In this exemplary interaction, a new content stream representation 1315 has been selected. The selected content stream may be dragged as is illustrated by the cursor 1330 and content representation 1365 to any location in the display area 1305. However, in some embodiments of the display, the content streams may not overlap in grid mode. In such aspects, the dragged content stream representation 1365 may snap to a suitable location as the content stream representation 1365 is dragged across the display area 1405. In other aspects of the display, simply selecting the content stream representation 1415 will cause the content stream 1460 to display in a suitable grid location. Once the interaction is complete, the newly presented content stream 1460 will be associated with a new group of pixels on the display. As shown in FIG. 3b it is still possible to move all 3 of the presented content streams 1350, 1355, and 1360 such that their locations may be swapped in the display 1300.

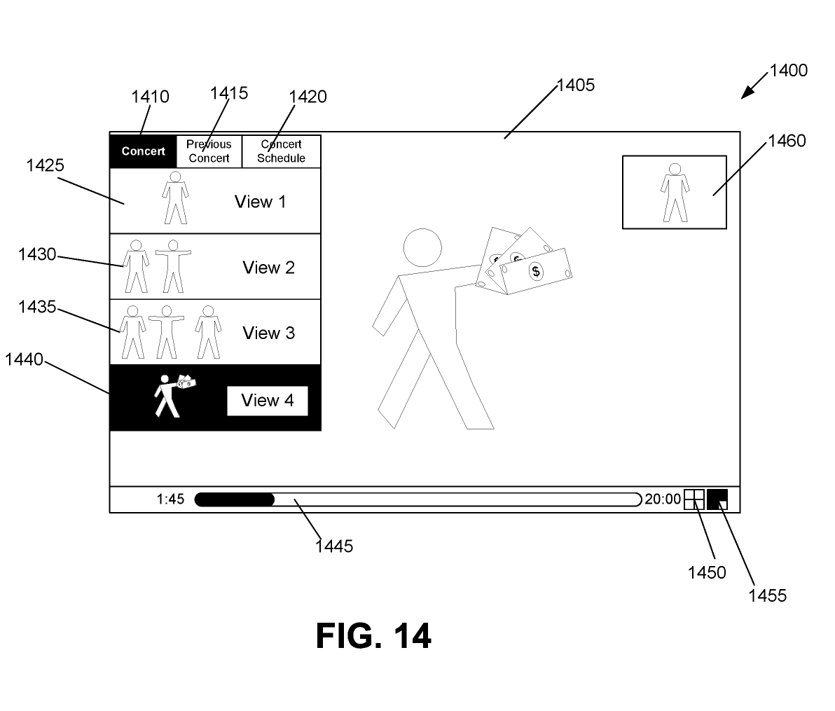

FIG. 14 illustrates an exemplary embodiment of a display 1400 presenting multiple events. The display 1400 includes a display area 1305, content stream representations 1425-1440, PiP content stream 1460, timeline 1445, and selectable objects 1450 and 1455. Many of the features in the display 1400 are similar to the features illustrated in FIG. 1. For instance, the content stream representations 1425-1440 are similar to content stream representations 125-140, the timeline 1445 is similar to the timeline 115, selectable objects 1450 and 1455 are similar to selectable objects 110 and 115, and PiP content stream 1460 is similar to PiP content stream 145. The same description of these features in FIG. 1 applies to FIG. 14.

The display 1400 may be presented after the content delivery server received a request to serve an instance of the content player 625 or 630 to the client apparatus 605 or 620. The difference between display 1400 and the previously described displays is the incorporation of the channel tabs 1410-1420. As described above, the content delivery apparatus has the ability to present multiple content streams associated with multiple channels at a display. In this exemplary embodiment, the channel tab 1410 is selected. A selected tab may be indicated by some sort of visual distinction such as a change in color or any visual appearance that provides a visual distinction from the other tabs. As shown, the channel tabs may be associated with both live and recorded content. However, all of the content is downloaded from the same content delivery server 330. Additionally, the tab 1420 enables a user to view a schedule of events. Such a tab may be useful for events that have various schedule performances such as a music festival.

The channel tab 1415, upon selection, may provide new content representations 1425-1440 because the tab may be associated with different content streams. As a result, at least one of the content streams associated with the channel tab 1615 may begin buffering upon receiving a selection of the tab at the display 1400. Thus, the new content streams associated with the channel tab 1415 can be presented at the display 1400. The display 1400 still provides all of the same functionality discussed in the previous exemplary displays, but with more content choices.

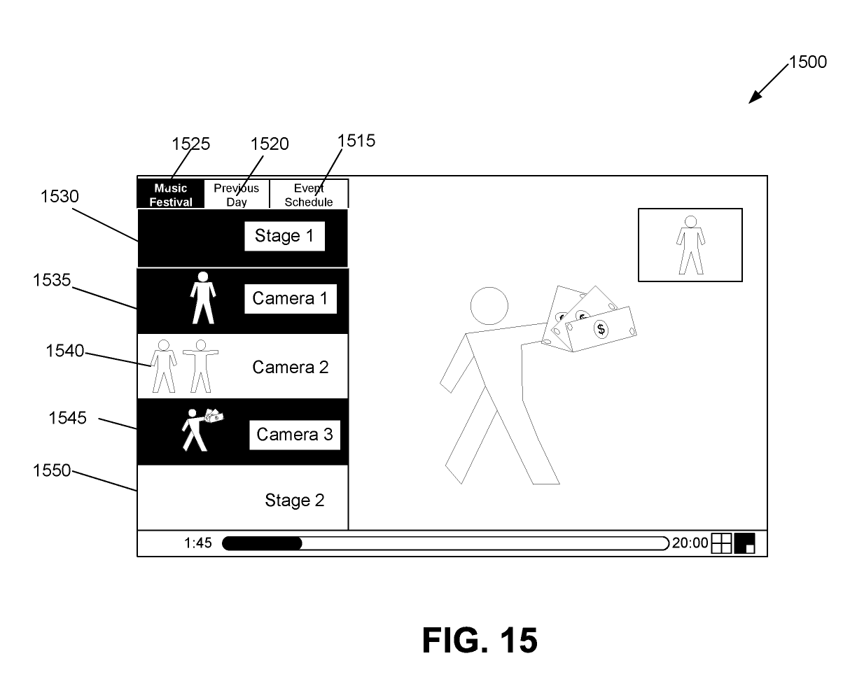

FIG. 15 illustrates an exemplary embodiment of a display 1500 that is capable of presenting different channels within an event. FIG. 15 is similar to FIG. 14, with the exception that at least one of the tabs 1515-1525 is now associated with an event, which has several different channels 1530 and 1550. The display 1500 is especially useful for events like a festival having several different stages for different performances, where each stage has various camera feeds capturing different angles of the stage. In this exemplary embodiment, a music festival associated with the tab 1525 has at least 2 different channels 1530 and 1550. As illustrated, channel 1530 has 3 associated content streams 1535-1545.

As discussed above, when the content player is served to a client apparatus, the platform 365 may check the CMS 410 for event information, channel information, and associated content streams. All of that information is downloaded to the content player and displayed as shown in the display 1500. In this exemplary embodiment, the channel 1530 has been selected. The channel 1530 may be automatically selected once the content player has been downloaded by the client and/or selected by a user interaction with the display 1500. Once the channel is selected, the client apparatus may begin buffering one or more of the associated content streams for presentation at the display 1500. However, if the display 1500 were to receive a selection of the channel 1550, then the client apparatus would automatically begin buffering the content streams associated with the newly selected channel.

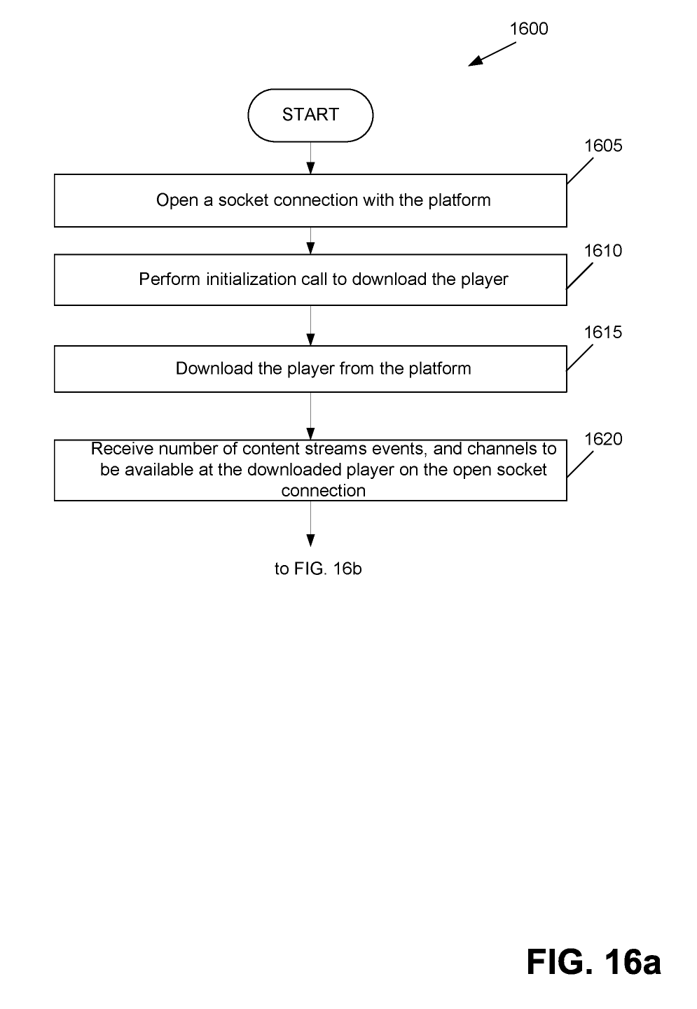

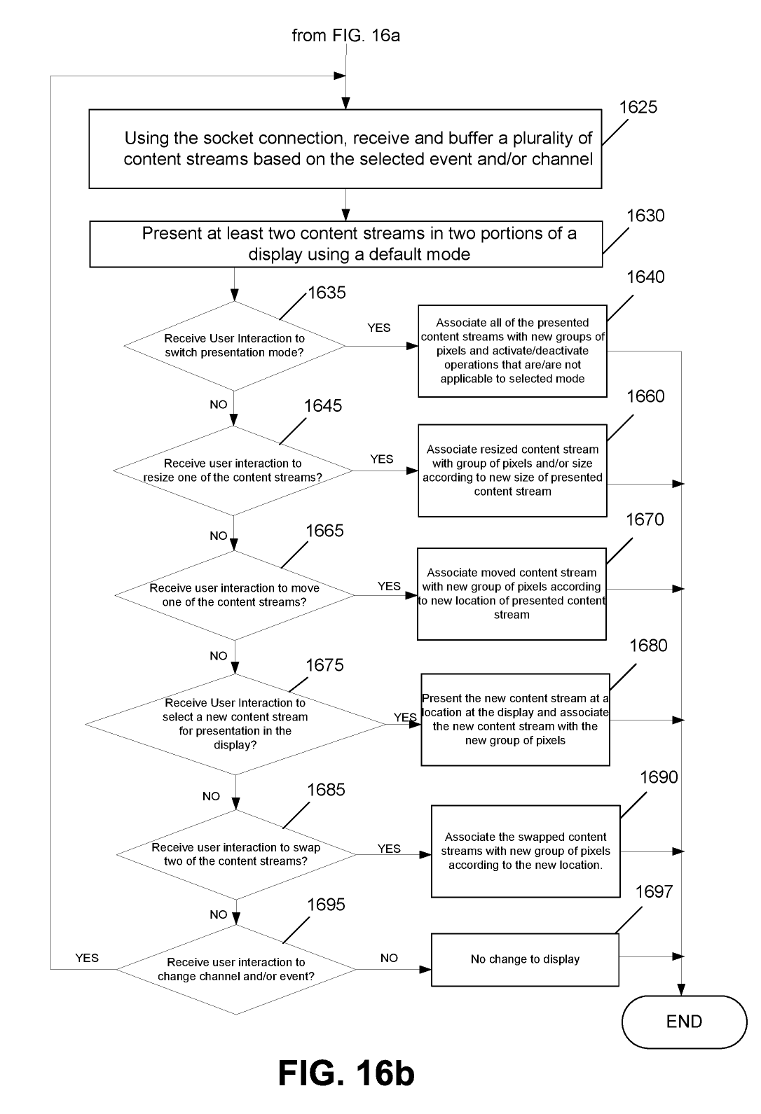

FIGS. 16a-b conceptually illustrate a process 1600 for providing a fully configurable content viewing experience. The process 1600 may be performed on a client apparatus such as the client apparatuses 605 and/or 620. The process 1600 may begin after a client apparatus has accessed an application or a website capable of downloading the content player.

As shown, the process 1600 opens (at 1605) a socket connection with the platform. The process 1600 performs an initialization call (at 1610) to download the content player to the client apparatus. The process 1600 downloads (at 1615) the content player from the platform. The process 1600 receives (at 1620) the number of content streams, events, and channels to be available at the downloaded content player on the open socket connection. As discussed above all of the content streams are available for playback on the same socket connection. By utilizing only one socket connection, the content player is capable of managing shared resources, which ensures an optimized viewing experience. For instance, if the client apparatus is running multiple content streams at the same time on an apparatus that has a slow processor, or if the content player detects a bandwidth below a particular threshold, the content player is able to lower the bit rate or quality of the content stream to provide a more desirable viewing experience. When not utilizing the same socket connection, the content player is unable to perform such resource management, which could lead to a distorted or very slow viewing experience.

The process 1600, using the socket connection, receives and buffers (at 1625) several of the content streams based on the selected event and/or channel. For instance, in situations where the content player downloads different channel and/or event information, the content player may select a default channel having several content streams and begin buffering those content streams until receiving user input selecting a different channel or event. The process 1600 presents (at 1630) at least two of the content streams in two portions of a display using a default mode. For instance the content streams may default to a grid mode of display.

At 1635, the process determines whether the content player has received user interaction to switch the presentation mode, when the process 1600 has received user interaction to switch the presentation mode, the process 1600 associates (at 1640) all of the presented content streams with new pixel groups based on the method discussed above with respect to FIG. 11. The process also may optionally activate/deactivate (at 1640) the operations that are available or not available to the selected mode. For instance, in some embodiments, the resize function may not be available in grid mode. In such instances, the process 1600 would deactivate the resize capability if grid mode is selected. The process then ends. When the process determines (at 1635) that no user interaction was received to switch the presentation mode, the process determines (at 1645) whether a user interaction to resize one of the content streams has been received. When a user interaction to resize (at 1645) one of the content streams has been received, the process 1600 associates (at 1660) the resized content stream with a new group of pixels according to the new size of the presented content stream using the method described above with respect to FIG. 11. The process then ends. When the process 1600 determines (at 1645) that no user interaction to resize one of the content streams has been received, the process determines (at 1665) whether user input to move one of the content streams has been received. When the process 1600 determines that user input to move one of the content streams has been received, the process 1600 associates (at 1670) the moved content stream with a new group of pixels according to the new location of the presented content stream and using the method described above with respect to FIG. 11. The process then ends. When the process 1600 determines (at 1665) that no user interaction to move the content stream has been received, the process 1600 determines (at 1675) whether user interaction to select a new content stream for presentation at the display has been received. When the process 1600 determines (at 1675) that user interaction to select a new content stream for presentation at the display has been received, the process 1600 presents (at 1680) the new content stream at a group of pixels on the display and associates the new content stream with new group of pixels using the method discussed above with respect FIG. 11. The process then ends. When the process 1600 determines (at 1675) that user input to select a new content stream for presentation at the display has not been received, the process 1600 determines (at 1685) whether user input to swap two of the content streams has been received. When the process 1600 determines (at 1685) that user interaction to swap the two content streams has been received, the process 1600 associates (at 1690) the swapped content streams with new pixel groups according to the new locations of the swapped content streams, using the method discussed above with respect to FIG. 11. The process then ends. When the process 1600 determines (at 1685) that no user interaction to swap the content streams has been received the process 1600 determines (at 1695) whether user input to change a channel and/or event has been received. When the process determines (at 1695) determines that such a user interaction has been received, the process 1600 returns to 1625 begin buffering the content streams associated with the selected channel and/or event. When the process 1600 determines (at 1695) that no such user interaction was received, the process 1600 makes no change (at 1697) to the display appearance. The process then ends.

As those skilled in the art will appreciate the process 1600 may continuously repeat while the content player is active and running. The process 1600 merely illustrates one iteration for providing a customizable viewing experience. However, multiple iterations should be run making the display fully customizable for the entire viewing experience.

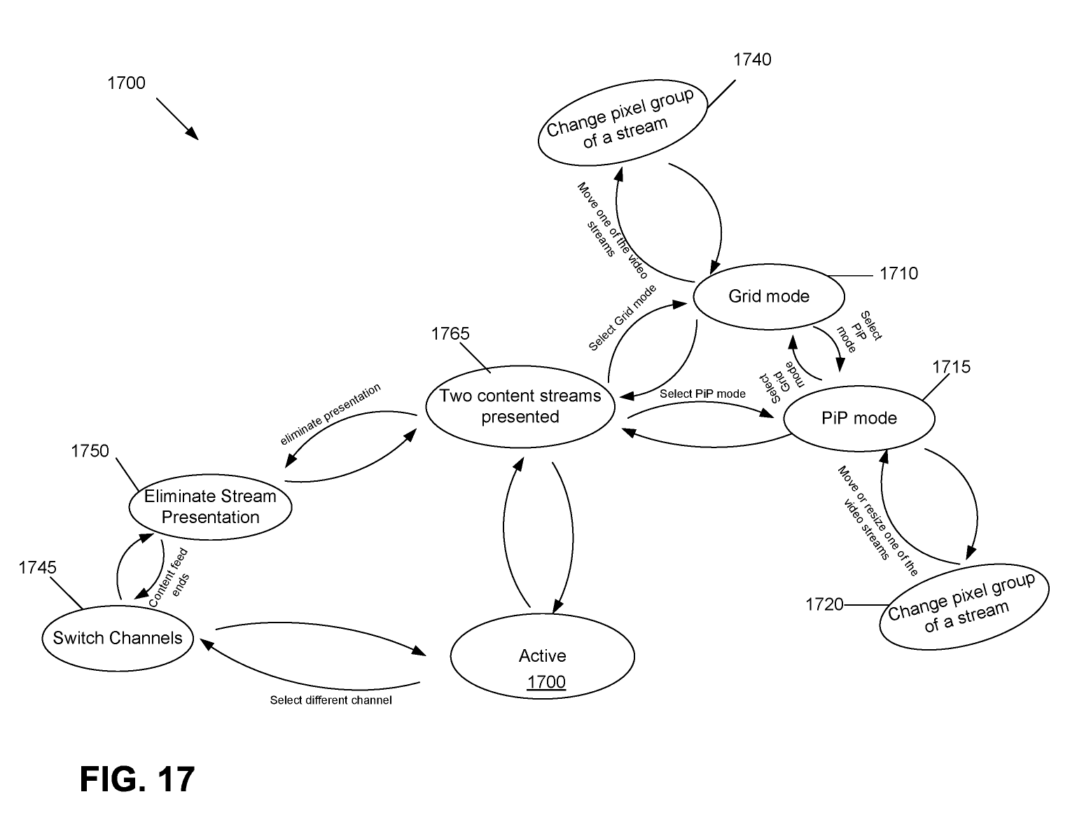

FIG. 17 illustrates an exemplary embodiment of a state diagram 1700 of a content player. Specifically, the state diagram illustrates an exemplary embodiment of a content switch such as the content switch 1025. The state diagram 1700 performs specific actions in response to events such as user interactions with the display. Those of ordinary skill in the art will recognize that the state diagram 1700 does not describe all states of the content switch, but instead specifically pertains to those functions that may be carried out in order to provide a customized viewing experience at a display.

As shown in FIG. 17, the content player (at 1700) is in an active state, meaning it has been downloaded to the client apparatus and may be presenting at least one content stream. From this state, the content player may transition to state 1765 to present at least two fully configurable content streams at a display. Once at least two content streams are presented, the content player may either transition to state 1710, where the content player presents the content stream in grid mode or to state 1715 where the content player presents the content streams in PiP mode. The content player may automatically default to one of these modes once at least two streams are presented or the content player may receive a selection of a selectable object as described in the previous figures, indicating the mode in which the content is to be displayed. The content player may also toggle between states 1710 and 1715 to switch between grid mode and PiP mode according to received user interaction. The PiP mode and Grid mode presentation formats were illustrated in FIGS. 12 and 13 respectively.

Once a presentation mode is established different customizability functions may be performed on one of the displayed content stream. For instance, when the content player is in the grid mode state 1710, the content player may transition to state 1740 to change the location of a stream. The location may be changed by moving one of the video streams as described in FIG. 13. Additionally, swapping content streams will bring the content player to the state 1740. After the location of at least one content stream has been changed, the content player returns to the state 1710.

Conversely, if the content player is in PiP mode, at the state 1715, the content player may enter state 1720 if a user interaction to move, resize, or swap one of the content streams is received. At state 1720, the content player will change the group of pixels of the display corresponding to the presented content stream. After the group of pixels is changed, the content player returns to the state 1715.

The content player may then return from the state 1710 or the state 1715 to the state 1765 and subsequently state 1750 when a stream is eliminated. This example assumes that only two content streams are presented. Thus, when a stream is eliminated the content player can no longer be in the state 1710 (grid mode) or the state 1715 (PiP mode). However, as described in the above figures, more than one content stream may be presented at a display. Thus, when a content stream is eliminated, the content player may remain in grid mode (at 1710) or PiP mode (at 1715). Alternatively, the content player may return from the state 1750 to the state 1765 when a second content stream is again presented. However, if the stream presentation was eliminated because the content feed has ended, the content player may enter state 1745 and switch channels to a feed that is currently active. For instance, if a performance on a particular channel ends, the content player may automatically switch to a channel where a performance is currently happening by entering state 1745. Using the same concert event example, if an artist were to finish a performance at a particular stage that is presented at the display, the content player may automatically switch to a channel associated with another stage where an artist is currently performing. Additionally, the content player may enter the state 1745 from the state 1700 by receiving a selection of a new channel. For instance, a selection may be received from a display similar to the ones described in FIGS. 14 and 15. Although not illustrated, the content player may also enter the state 1745 from the state 1710 and the state 1715 by the same event that brings the content player to the state 1700.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

1. A server apparatus comprising:
a content player; and
an interface configured to serve the content player to a client apparatus;
wherein the content player is configured to operate on the client apparatus by receiving a plurality of content streams through a single socket connection and presenting each of the content streams to a different portion of a display, the manner of presentation being configurable by a user of the client apparatus.

2-52. (canceled)

53. A content player comprising non-transitory machine-readable medium having executable code to:
receive a plurality of content streams through a single socket connection; and
present each of the content streams to a different portion of a display, the manner of presentation being configurable by a user of the content player.

54. The content player of claim 53, wherein the machine-readable medium further comprises code executable to assign a location of each of the different portions of the display based on input received from the user.

55. The content player of claim 54, wherein each of the different portions comprises a pixel group, and wherein the code executable to assign the location is configure to assign at least one of the content streams currently configured to present to the display to a new pixel group on the display.

56. The content player of claim 54, wherein the code executable to present the content streams is configured to present the different portions in a grid format such that the group of pixels assigned to one of the different portions comprises edge pixels that are adjacent to edge pixels on an opposite side of another one of the different portions.

57. The content player of claim 54, where the code executable to presented the content streams is configured to present the content streams in a manner in which one of the different portions of the display is a assigned a first pixel group and another of the different portions of the display is assigned a second pixel group that is a subset of the first pixel group, and wherein only said another of the different portions is presented at the second pixel group.

58. The content player of claim 54, wherein when the location of at least one of the different portions of the display is reconfigured by the user, and where in the code executable to define the location is configured to associate said at least one of the different portions with a new group of pixels on the display.

59. The content player of claim 53, wherein the machine-readable medium further comprises code executable to configure size of each of the different portions based on input received from the user.

60. The content player of claim 59, wherein code executable to configure the size of each of the different portions of the display is configured to adjust a corresponding group of pixels assigned thereto.

61. (canceled)

62. The content player of claim 53, wherein the code executable to present the content streams is configured to receive a selection from a user of at least one of the plurality of the content streams for presentation to the different portions of the display.

63. The content player of claim 62, wherein the code executable to present the content streams is further configured to receive an additional content stream through the single socket connection.

64. (canceled)

65. (canceled)

66. A content player comprising a machine-readable medium having software instructions executable to:
receive a plurality of content streams; and
coordinate allocation of resources to present each of the content streams to a different portion of a display, the manner of presentation being configurable by a user of the content player.

67. The content player of claim 66, wherein the machine-readable medium further comprises code executable to assign a location of each of the different portions of the display based on input received from the user.

68. The content player of claim 67, wherein each of the different portions comprises a pixel group, and wherein the code executable to assign the location is configure to assign at least one of the content streams currently configured to present to the display to a new pixel group on the display.

69. The content player of claim 67, wherein the code executable to coordinate the allocation of resources is configured to present the different portions in a grid format such that the group of pixels assigned to one of the different portions comprises edge pixels that are adjacent to edge pixels on an opposite side of another one of the different portions.

70. The content player of claim 67, where the code executable to coordinate the allocation of resources is configured to present the content streams in a manner in which one of the different portions of the display is a assigned a first pixel group and another of the different portions of the display is assigned a second pixel group that is a subset of the first pixel group, and wherein only said another of the different portions is presented at the second pixel group.

71. The content player of claim 67, wherein when the location of at least one of the different portions of the display is reconfigured by the user, and wherein the code executable to define the location is configured to associate said at least one of the different portions with a new group of pixels on the display.

72. The content player of claim 66, wherein the machine-readable medium further comprises code executable to configure size of each of the different portions based on input received from the user.

73. The content player of claim 72, wherein code executable to configure the size of each of the different portions of the display is configured to adjust a corresponding group of pixels assigned thereto.

74. (canceled)

75. The content player of claim 66, wherein the code executable to coordinate the allocation of resources is configured to:
receive a selection from a user of at least one of the plurality of the content streams for presentation to the different portions of the display; and
receive an additional content stream through the single socket connection.

76-78. (canceled)
